(19) United States
(12) Patent Application Publication
(10) Pub. No.: US 2025/0360849 A1
(43) Pub. Date: Nov. 27, 2025

(54) CHILD RESTRAINT

(71) Applicant: Dorel Juvenile Group, Inc., Foxboro, MA (US)

(72) Inventors: Jonathan M. Holtman, Brownsburg, IN (US); Jason H. Johnson, Brownstown, IN (US); Matthew R. Larrison, Columbus, IN (US)

(21) Appl. No.: 19/213,506

(22) Filed: May 20, 2025

Related U.S. Application Data
(60) Provisional application No. 63/650,082, filed on May 21, 2024.
(60) Provisional application No. 63/752,224, filed on Jan. 31, 2025.

(51) Int. Cl. B60N 2/28

(52) U.S. Cl. CPC B60N 2/2884; B60N 2/2812; B60N 2/2872

(57) ABSTRACT

A child restraint includes a seat bottom and a backrest coupled to the seat bottom and extending upwardly away from the seat bottom. The child restraint further includes a side-impact management system. The side-impact management system includes a child-restraint harness coupled to the seat bottom and the seat back and configured to block movement of a child relative to the seat bottom and the seat back, a first side wing coupled to a first lateral end of the backrest, and a second side wing coupled to a second lateral end of the backrest.

### PRIORITY CLAIM

This application claims priority under 35 U.S.C. § 119 (e) to U.S. Provisional Patent Application No. 63/650,082, filed May 21, 2024 and U.S. Provisional Patent Application No. 63/752,224, filed Jan. 31, 2025, each of which is expressly incorporated by reference herein in its entirety.

### BACKGROUND

The present disclosure relates to a child safety device, and particularly to a child seat. More particularly, the present disclosure relates to a child seat for use in a vehicle.

### SUMMARY

According to the present disclosure, a child restraint includes a seat bottom and a backrest coupled to the seat bottom and extending upwardly away from the seat bottom. The child restraint may include an integral headrest coupled to the backrest or a movable headrest coupled to the backrest and movable upwardly and downwardly along the backrest.

In illustrative embodiments, the child restraint further includes a side-impact management system. The side-impact management system includes a child-restraint harness coupled to the seat bottom and the seat back and configured to block movement of a child relative to the seat bottom and the seat back, a first side wing coupled to a first lateral end of the backrest, and a second side wing coupled to a second lateral end of the backrest.

In illustrative embodiments, each of the side wings are formed to include a shoulder-receiving, side-impact recess. The shoulder-receiving, side-impact recess is configured to receive the shoulder and/or arm region of the child during a side impact to cause the child-restraint harness to catch the child and to reduce a lateral force on the child from the side wings so that chest displacement of the child is minimized.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a child restraint including a seat shell at least partially defining a child-receiving space and a side-impact management system coupled to the seat shell and configured to reduce chest displacement of a child seated in the child-receiving space, the side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 2 is a front plane view of the child restraint and a child seated in the child-receiving space in a pre-impact state;

FIG. 3 is a front plane view of the child restraint and the child in an impact state during a side impact where the child has moved toward one of the side wings, or one of the side wings has moved toward the child, and showing the child's shoulder and/or arm region received in the shoulder-receiving, side-impact recess while the child-restraint harness catches a torso of the child to limit the chest displacement of the child;

FIG. 4 is a cross section of a portion of the child restraint taken along line 4-4 in FIG. 1 showing one of the side wings including a rear segment coupled to a backrest of the seat shell, a laterally-extending segment coupled to a forward end of the rear segment and extending laterally away from the backrest, and an outwardly-extending segment coupled to an outer end of the laterally-extending segment and extending forward away from the laterally-extending segment, the rear segment, and the backrest, and showing the laterally-extending segment and the outwardly-extending segment at least partially defining the recess;

FIG. 5 is an enlarged perspective view of a portion of the child restraint of FIG. 1 showing the first side wing including an upper section configured to support a head of a child, a lower section configured to support a hip region of the child, and a medial section between the upper section and the lower section and formed to include the recess configured to receive the shoulder region of the child during the side impact;

FIG. 6 is a perspective view of a second embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 7 is a cross section taken along line 7-7 in FIG. 6 showing the first and second side wings each including a rear segment coupled to a backrest of the seat shell, a laterally-extending segment coupled to a forward end of the rear segment and extending laterally away from the backrest, and an outwardly-extending segment coupled to an outer end of the laterally-extending segment and extending forward away from the laterally-extending segment, the rear segment, and the backrest, and showing the laterally-extending segment and the outwardly-extending segment at least partially defining the recess and the outwardly-extending segment having a greater thickness then the rest of the child restraint;

FIG. 8 is a perspective view of a third embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 9 is a cross section taken along line 9-9 in FIG. 8 showing the first and second side wings each including a rear segment coupled to a backrest of the seat shell, a laterally-extending segment coupled to a forward end of the rear segment and extending laterally away from the backrest, and an outwardly-extending segment coupled to an outer end of the laterally-extending segment and extending forward away from the laterally-extending segment, the rear segment, and the backrest, and showing the laterally-extending segment and the outwardly-extending segment at least partially defining the recess and a plurality of ribs coupled to an outer surface of the outwardly-extending segment;

FIG. 10 is a perspective view of a fourth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 11 is a cross section taken along line 11-11 in FIG. 10 showing the first and second side wings each including a rear segment coupled to a backrest of the seat shell, an angled laterally-extending segment coupled to a forward end of the rear segment and extending laterally away from the backrest, and an outwardly-extending segment coupled to an outer end of the laterally-extending segment and extending forward away from the laterally-extending segment, the rear segment, and the backrest, and showing the laterally-extending segment and the outwardly-extending segment at least partially defining the recess and a plurality of ribs coupled to an outer surface of the outwardly-extending segment;

FIG. 12 is a perspective view of a fifth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 13 is a cross section taken along line 13-13 in FIG. 12 showing the first and second side wings each including a rear segment coupled to a backrest of the seat shell, an angled laterally-extending segment coupled to a forward end of the rear segment and extending laterally away from the backrest, and an outwardly-extending segment coupled to an outer end of the laterally-extending segment and extending forward away from the laterally-extending segment, the rear segment, and the backrest, and showing the laterally-extending segment and the outwardly-extending segment at least partially defining the recess and a tip of the outwardly-extending segment having a greater thickness then the rest of the child restraint;

FIG. 14 is a perspective view of a sixth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell;

FIG. 15 is a cross section taken along line 15-15 in FIG. 14 showing the first and second side wings each including a side panel and a turn-back flange coupled to a distal end of the side panel;

FIG. 16 is a perspective view of a seventh embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 17 is a side plane view taken of the child restraint of FIG. 16 showing the first and second side wings each including a rear segment coupled to a backrest of the seat shell, and a laterally-extending segment coupled to a forward end of the rear segment and extending laterally away from the backrest, and showing the laterally-extending segment at least partially defining the recess and the recess being unbounded in a lateral direction away from the child to derestrict the shoulder region of the child for movement in the lateral direction during the side impact;

FIG. 18 is a perspective view of an eighth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized;

FIG. 19 is a cross section taken along line 19-19 in FIG. 18 showing the first and second side wings each including a rear segment coupled to a backrest of the seat shell, a first laterally-extending segment coupled to a forward end of the rear segment and extending laterally away from the backrest, an outwardly-extending segment coupled to an outer end of the laterally-extending segment and extending forward away from the laterally-extending segment, the rear segment, and the backrest, and a second laterally-extending segment coupled to an outer end of the outwardly-extending segment and extending in a lateral direction toward the child-receiving space;

FIG. 20 is a perspective view of a nineth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing that the recess provides a deformable panel in each of the side wings configured to deform in response to the child's shoulder contacting the side wing to allow the child's shoulder to move relative to the rest of the child restraint;

FIG. 21 is a perspective view of a tenth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing that the recess is unbounded in a lateral direction to derestrict movement of the child's shoulder region in the lateral direction during the side impact;

FIG. 22 is a front plane view of an eleventh embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 23 is a cross section taken along line 23-23 in FIG. 22 showing the child restraint and scales where the child restraint is drawn to scale to show various dimensions of the recess and dimensional relationships of the recess to other features of the child restraint;

FIG. 24 is a cross section taken along the same plane as FIG. 23 but with a headrest of the child restraint removed to show the scales where the child restraint is drawn to scale to show various dimensions of the recess and dimensional relationships of the recess to other features of the child restraint;

FIG. 25 is a front plane view of a twelfth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 26 is a cross section taken along line 26-26 in FIG. 25 showing the child restraint and scales where the child restraint is drawn to scale to show various dimensions of the recess and dimensional relationships of the recess to other features of the child restraint;

FIG. 27 is a cross section taken along the same plane as FIG. 26 but with a headrest of the child restraint removed to show the scales where the child restraint is drawn to scale to show various dimensions of the recess and dimensional relationships of the recess to other features of the child restraint;

FIG. 28 is a front plane view of a thirteenth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 29 is a cross section taken along line 29-29 in FIG. 28 showing the child restraint and scales where the child restraint is drawn to scale to show various dimensions of the recess and dimensional relationships of the recess to other features of the child restraint;

FIG. 30 is a cross section taken along the same plane as FIG. 29 but with a headrest of the child restraint removed to show the scales where the child restraint is drawn to scale to show various dimensions of the recess and dimensional relationships of the recess to other features of the child restraint;

FIG. 31 is a front plane view of a fourteenth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 32 is a cross section taken along line 32-32 in FIG. 31 showing the child restraint and scales where the child restraint is drawn to scale to show various dimensions of the recess and dimensional relationships of the recess to other features of the child restraint;

FIG. 33 is a front plane view of a fifteenth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 34 is a cross section taken along line 34-34 in FIG. 33 showing the child restraint and scales where the child restraint is drawn to scale to show various dimensions of the recess and dimensional relationships of the recess to other features of the child restraint;

FIG. 35 is a cross section taken along the same plane as FIG. 34 but with a headrest of the child restraint removed to show the scales where the child restraint is drawn to scale to show various dimensions of the recess and dimensional relationships of the recess to other features of the child restraint;

FIG. 36 is a front plane view of a sixteenth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 37 is a cross section taken along line 37-37 in FIG. 36 showing the child restraint and scales where the child restraint is drawn to scale to show various dimensions of the recess and dimensional relationships of the recess to other features of the child restraint;

FIG. 38 is a cross section taken along the same plane as FIG. 37 but with a headrest of the child restraint removed to show the scales where the child restraint is drawn to scale to show various dimensions of the recess and dimensional relationships of the recess to other features of the child restraint;

FIG. 39 is a front plane view of a seventeenth embodiment of a child restraint including a seat shell and a side-impact management system including a child-restraint harness configured to secure the child to the seat shell, a first side wing coupled to a first lateral side of the seat shell, and a second side wing coupled to a second lateral side of the seat shell, and showing that the first and second side wings are each formed to include a shoulder-receiving, side-impact recess configured to receive the shoulder and/or arm region of the child during a side impact to cause the child-restraint harness to catch the child and to reduce a lateral force on the child from the side wings so that chest displacement of the child is minimized, and showing a scale where the child restraint is drawn to scale to show various dimensions of the recess and dimensional relationships of the recess to other features of the child restraint;

FIG. 40 is a cross section taken along line 40-40 in FIG. 39 showing the child restraint and scales where the child restraint is drawn to scale to show various dimensions of the recess and dimensional relationships of the recess to other features of the child restraint; and

FIG. 41 is a cross section taken along the same plane as FIG. 40 but with a headrest of the child restraint removed to show the scales where the child restraint is drawn to scale to show various dimensions of the recess and dimensional relationships of the recess to other features of the child restraint.

### DETAILED DESCRIPTION

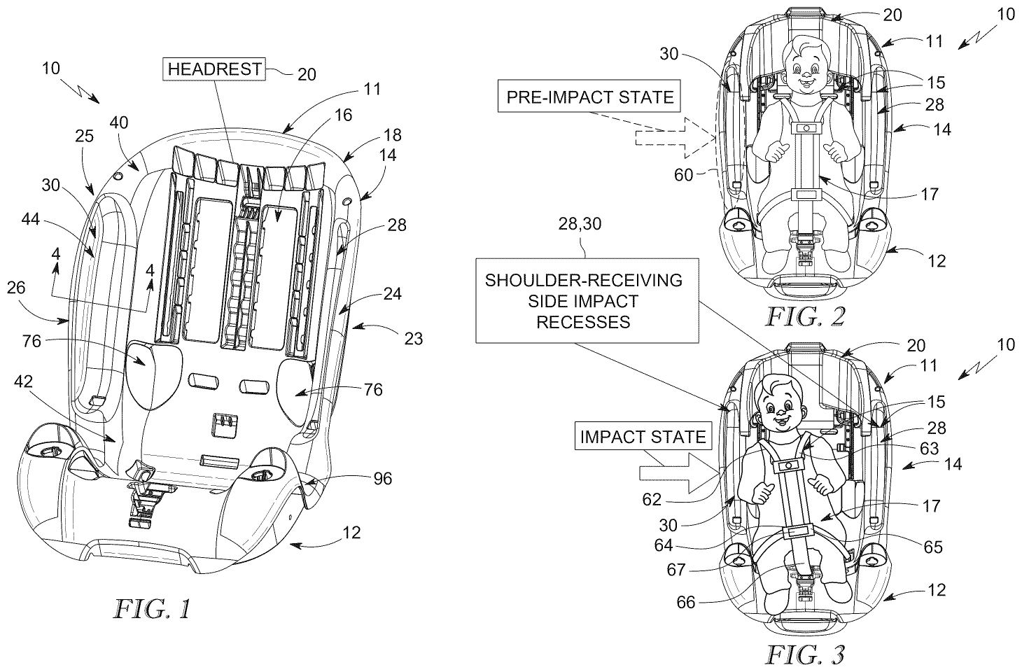

A child restraint 10 includes a seat shell 11 and is formed to include a child-receiving space 16 configured to hold a child for transportation in a vehicle as shown in FIGS. 1-3. The seat shell 11 includes a seat bottom 12 and a seat back 14 coupled to the seat bottom 12. The seat back 14 includes a backrest 18 extending upwardly away from the seat bottom 12 and a headrest 20 coupled to the backrest 18. The seat bottom 12 and the seat back 14 at least partially define the child-receiving space 16. The headrest 20 may be integral with and in a fixed position relative to the backrest 18, or the headrest 20 may be mounted to the backrest 18 for upward and downward sliding movement relative to the backrest 18 between a raised position and a lowered position.

In illustrative embodiments, the child restraint 10 further includes a side-impact management system 15 coupled to at least one of the seat bottom 12 and the seat back 14 as shown in FIGS. 1-3. The side-impact management system 15 is configured to provide means for managing chest displacement of the child during a side impact to reduce a lateral force on a shoulder region of the child during the side impact so that chest displacement of the child is minimized.

The side-impact management system 15 includes a child-restraint harness 17 coupled to the seat shell 11, a first side wing 24 coupled to a first lateral side 23 of the backrest 18 and projecting forward therefrom, and a second side wing 26 coupled to a second lateral side 25 of the backrest and projecting forward therefrom as shown in FIGS. 1-3. The child-restraint harness 17 includes a pair of shoulder straps 62, 63, a latch 64, 65 coupled to each respective shoulder strap 62, 63, a crotch strap 66 and a buckle 67 coupled to the crotch strap and configured to engage selectively with the latches 64, 65 to restrain the child in the child-receiving space 16. Each side wing 24, 26 is formed to include a shoulder-receiving side-impact recess 28, 30. The shoulder-receiving side-impact recess 28, 30 of the first side wing 24 or the second side wing 26 is configured to receive the shoulder and/or arm region of the child during the side impact event.

The side-impact recesses 28, 30 allow movement of the shoulder region of the child toward one of the side wings 24, 26 for a period of time during the side impact event so that the child-restraint harness 17 catches the torso of the child before the shoulder and/or arm region of the child compresses against one of the side wings 24, 26 to minimize chest displacement of the child. In other words, the child-restraint harness 17 is configured to block movement of a torso of the child relative to the seat shell 11 while the recesses 28, 30 provide spacing for the child's shoulder and arm region to move slightly during a side impact event. When the harness 17 is properly tensioned according to manufacturer instructions, the harness 17 is configured to catch the torso of the child before the child's shoulder and/or arm region engages one of the side wings 24, 26 during a side impact, thereby reducing forces on the child's shoulder and arm region, or a side region of the child's torso, and lowering chest displacement of the child.

The child restraint 10 further includes an outer trim 60 covering each shoulder-receiving side-impact recess 28, 30 of the side wings 24, 26 as shown in FIG. 2. The outer trim 60 is spaced apart from at least a portion of each side wing 24, 26 so that each recess 28, 30 provides an empty space between the outer trim 60 and at least the portion of each side wing 24, 26. The outer trim 60 may be a flexible soft-goods or fabric. In some embodiments, the child's shoulder and/or arm regions extend into the recesses 28, 30 without contacting any rigid or force-reducing structures (e.g. relatively stiff foam, airbag, etc.). In some embodiments, the recess 28, 30 is filled at least partially with a low-density foam material or a high-rate deflateable airbag to allow movement of the child's shoulder and/or arm region quickly into the recess 28, 30 during the side impact.

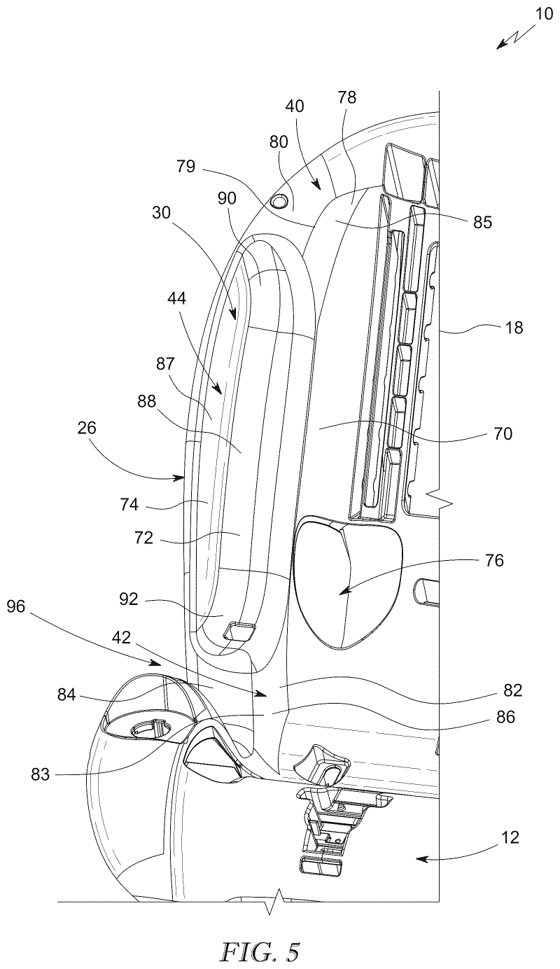

Each of the side wings 24, 26 includes an upper panel or section 40, a lower panel or section 42, and a medial panel or section 44 as shown in FIGS. 1 and 5. The upper panel 40 may be a part of the backrest 18 or the headrest 20 and is configured to restrain directly or indirectly the head of the child during the side impact event. In other words, the headrest 20 may act as the upper panel 40, particularly in a child's younger years when their height is less. The lower panel 42 is configured to restrain a hip region of the child during the side impact event. The medial panel 44 extends between and interconnects the upper panel 40 and the lower panel 42. The recesses 28, 30 are defined below each respective upper panel 40, above each respective lower panel 42, and laterally adjacent to at least a portion of each respective medial panel 44. In other words, the medial panel 44 is formed to include the recess 28, 30 such that at least a portion of the medial panel 44 is laterally further from the child than the upper panel 40 and the lower panel 42 to provide the spacing for the child's shoulder and/or arm regions during side impacts. The recesses 28, 30 have a sufficient height to accommodate the shoulder and arm region of the child across a wide variety of child heights (i.e. any height within a range of about 20 inches to about 60 inches, in particular about 25 inches to about 57 inches).

The medial panel 44 may contact and support the shoulder or arm region of the child during side impacts, but the upper and lower panels 40, 42 may be configured to engage the child before the medial panel 44 during the side impact event. Instead of restraining the child's shoulder and/or arm region with the side wings 24, 26, the recesses 28, 30 allow the shoulder and/or arm region of the child to remain spaced from the side wings 24, 26 for a period of time during the side impact event so that the child is restrained primarily by the harness 17. In other words, the recesses 28, 30 provide spacing for the child's shoulder and arm region to move laterally in a first direction toward one of the side wings 24, 26, or the side wing 24, 26 to move laterally in an opposite, second direction toward the child, during the side impact event so that the harness 17 catches and restrains the torso of the child to cause a lateral force on the shoulder and arm region of the child to be reduced so that chest displacement of the child is minimized.

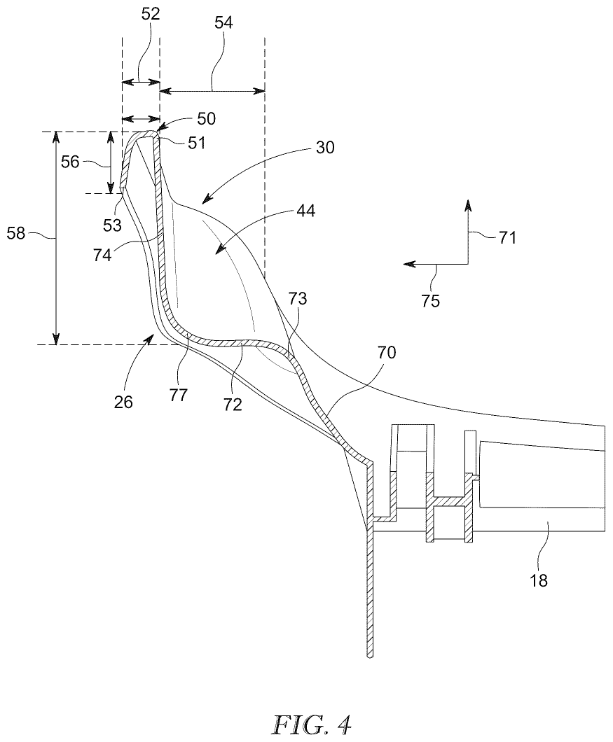

The medial panel 44 includes a rear segment 70 coupled to the backrest 18, a laterally-extending segment 72 coupled to the rear segment 70, and an outwardly-extending segment 74 coupled to the laterally-extending segment 72 as shown in FIGS. 4 and 5. The rear segment 70 extends away from the backrest 18 in at least a forward direction 71 of the child restraint 10. The laterally-extending segment 72 is coupled to a forwardmost end 73 of the rear segment 70 and extends away from the rear segment 70 in a lateral direction 75. The forward direction 71 is substantially perpendicular (i.e. between 85 degrees and 95 degrees) to the lateral direction 75. The outwardly-extending segment 74 is coupled to an outermost end 77 of the laterally-extending segment 72 and extends away from the backrest 70 in the forward direction 71. The recess 28 is defined forward of the laterally-extending segment 72 and laterally adjacent to the outwardly-extending segment 74. The rear segment 70 may extend in the forward direction 71 and the lateral direction 75 (i.e. at an angle away from the backrest 18).

In some embodiments, the rear segment 70 may be formed to include a pair of first belt-path apertures 76 located rearward of the recesses 28, 30 and may further include a pair of second belt-path apertures 96 located forward of the first belt-path apertures 76 as shown in FIGS. 1 and 5. The belt-path apertures 76 may be formed entirely in the rear segment 70 of each side wing 24, 26 or partially in the rear segment 70 and partially in the backrest 18. The belt path apertures 76 extend all the way through the seat shell 11 and are configured to receive an attachment belt, such as a vehicle seat belt or a separate belt from the vehicle, to secure the child restraint 10 to the vehicle seat. The second belt-path apertures 96 are located beneath the recesses 28, 30 and/or forward of the recesses 28, 30.

The upper panel 40 includes an outwardly-extending segment 78 coupled to the backrest 18 and a laterally-extending segment 80 as shown in FIGS. 4 and 5. The outwardly-extending segment 78 extends away from the backrest 18 in the forward direction 71 with the rear segment 70 of the medial panel 44. The laterally-extending segment 80 is coupled to a forwardmost end 79 of the outwardly-extending segment 78 and extends away from the outwardly-extending segment 78 in the lateral direction 75 with the laterally-extending segment 72 of the medial panel 44.

The lower segment 42 includes an outwardly-extending segment 82 coupled to the backrest 18 and a laterally-extending segment 84 as shown in FIG. 5. The outwardly-extending segment 82 extends away from the backrest 18 in the forward direction 71 with the rear segment 70 of the medial panel 44. The laterally-extending segment 84 is coupled to a forwardmost end 83 of the outwardly-extending segment 82 and extends away from the outwardly-extending segment 82 in the lateral direction 75 with the laterally-extending segment 72 of the medial panel 44.

The outwardly-extending segment 78 of the upper segment 40 is congruent with the rear segment 70 of the medial panel 44 such that it is spaced a smaller distance from a centerline of the child restraint 10 in comparison to the outwardly-extending segment 74 of the medial panel 44. The outwardly-extending segment 82 of the lower segment 42 is also congruent with the rear segment 70 of the medial panel 44 such that it is spaced a smaller distance from a centerline of the child restraint 10 in comparison to the outwardly-extending segment 74 of the medial panel 44. These spacing relationships provide the recesses 28, 30 and establish an upper side-impact barrier surface 85 by way of the outwardly-extending segment 78 of the upper panel 40, a lower side-impact barrier surface 86 by way of the outwardly-extending segment 82 of the lower panel 42, and a medial side-impact barrier surface 87 by way of the outwardly-extending segment 74 of the medial panel 44. The medial side-impact barrier surface 87 is spaced further from the centerline of the child restraint 10 than the upper and lower side-impact barrier surfaces 85, 86 and extends along a majority of a height of the backrest 18 (i.e. greater than 50%).

In some embodiments, the medial side-impact barrier surface 87 has a height that is at least 50% of the height of the side wings 24, 26. In some embodiments, the medial side-impact barrier surface 87 has a height that is at least 60% of the height of the side wings 24, 26. In some embodiments, the medial side-impact barrier surface 87 has a height that is at least 70% of the height of the side wings 24, 26. In some embodiments, the medial side-impact barrier surface 87 has a height that is at least 80% of the height of the side wings 24, 26. In some embodiments, the medial side-impact barrier surface 87 has a height that is at least 90% of the height of the side wings 24, 26. Such heights ensure the recesses 28, 30 are sufficiently sized to accommodate the shoulder and arm region of the child across a wide range of child heights and ages.

The laterally-extending segment 72 of the medial panel 44 includes a substantially linear middle segment 88, an upper curved segment 90, and a lower curved segment 92 as shown in FIG. 5. The middle segment 88 extends between and interconnects the upper segment 90 and the lower segment 92. The upper segment 90 is coupled to an upper end of the substantially linear middle segment 88 and to a forwardmost end of the upper panel 40. The lower curved segment 92 is coupled to a lower end of the substantially linear middle segment 88 and to a forwardmost end of the lower panel 42.

The seat shell 11 further includes a turn-back flange 50 having an inner end 51 coupled to an outer end of the upper panel 40, the medial panel 44, and the lower panel 42 as shown in FIGS. 4 and 5. The turn-back flange has a first width 52 defined between the inner end 51 of the turn-back flange 50 and an outer end 53 of the turn-back flange 50. The recesses 28, 30 have a second width 54 defined between the outer end of the outwardly-extending segment 74 of the medial panel 44 and the forwardmost end 73 of the rear segment 70 of the medial panel 44. The second width 54 is greater than the first width 52. The second width 54 is also greater than or equal to a third width 55 defined between the forwardmost end 79 of the outwardly-extending segment 78 of the upper panel 40 and the outer end of the upper panel 40. The turn-back flange 50 also has a depth 56 that is less than a depth 58 of the recesses 28, 30.

The recesses 28, 30 may provide means for allowing a shoulder region of a child seated in the child-receiving space to move into the recess during a side impact event so that impact forces experienced by the child during the side impact event are reduced. The recesses 28, 30 may provide means for satisfying federal safety standard FMVSS 213a. The recesses 28, 30 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

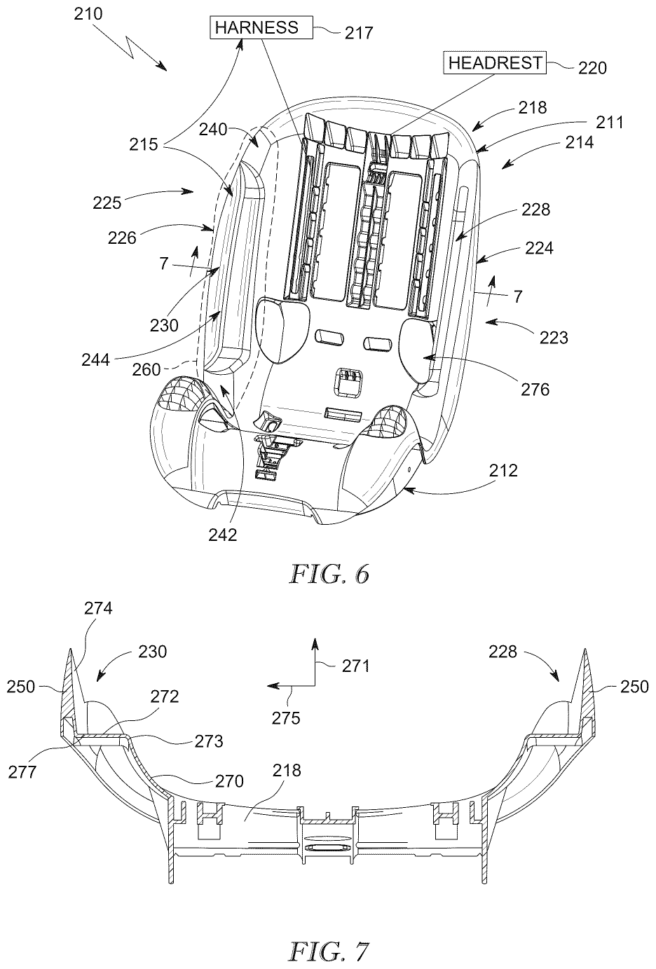

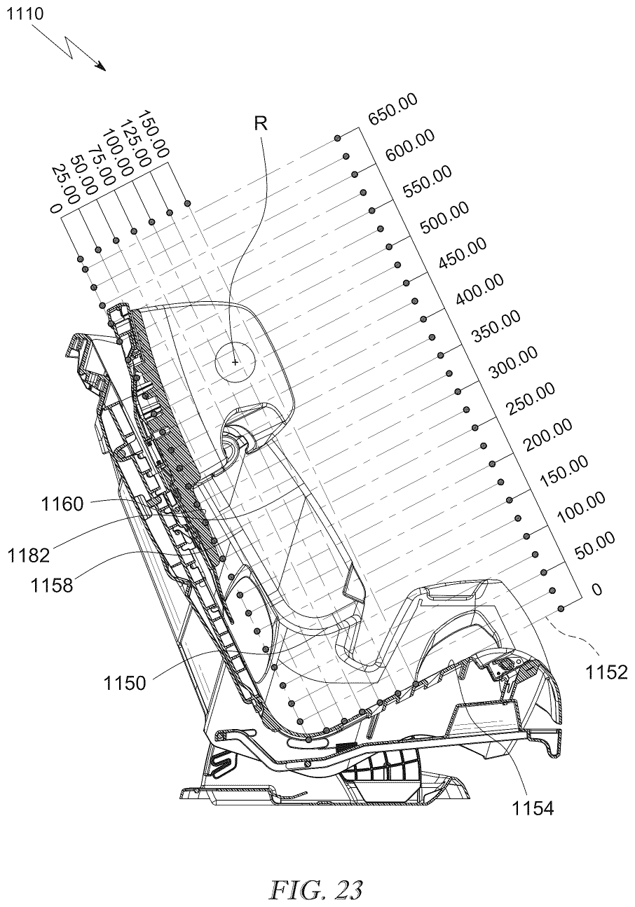

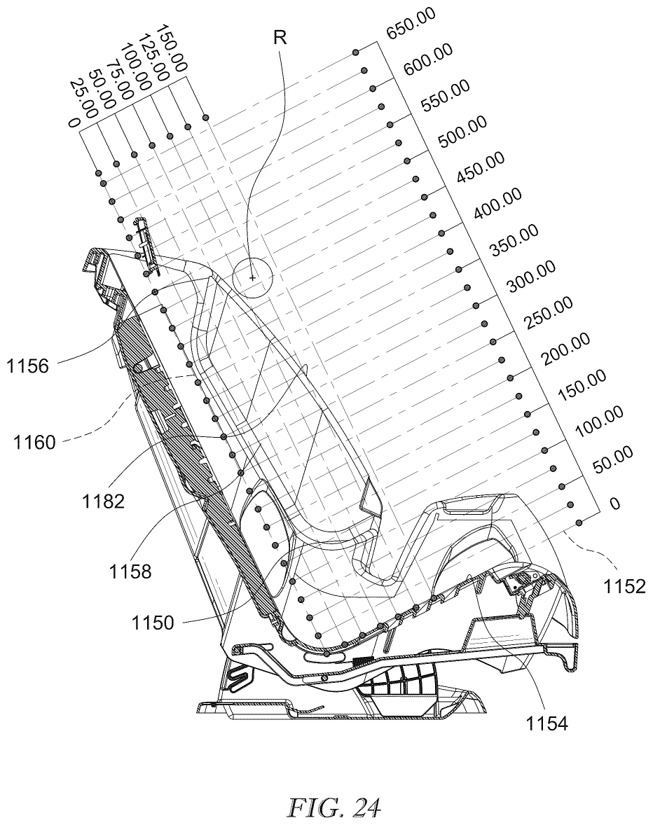

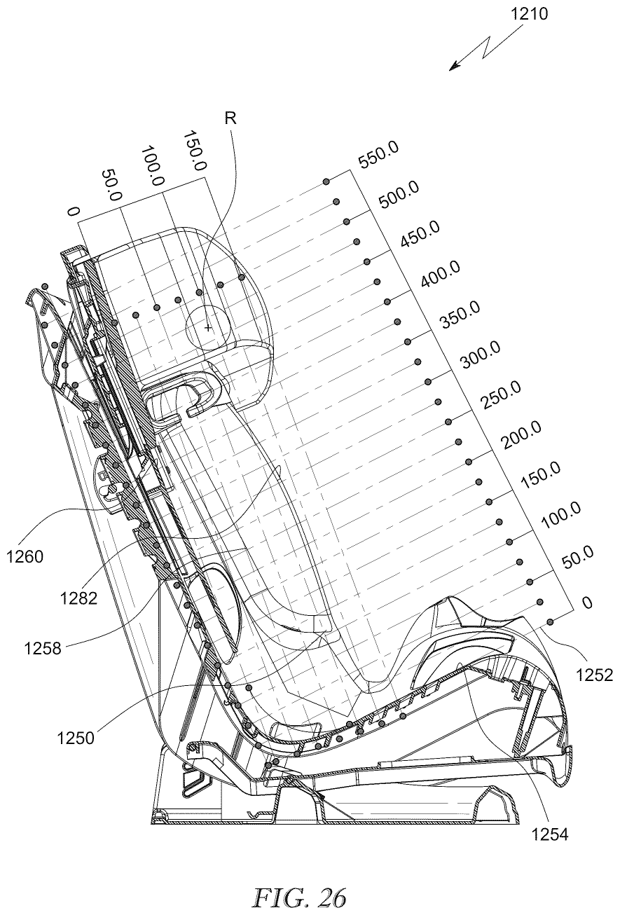

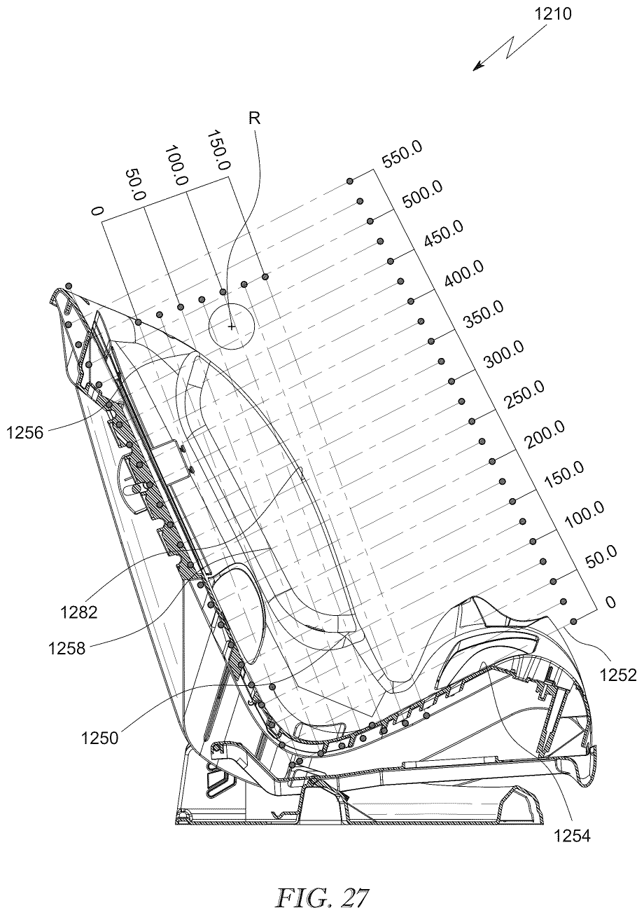

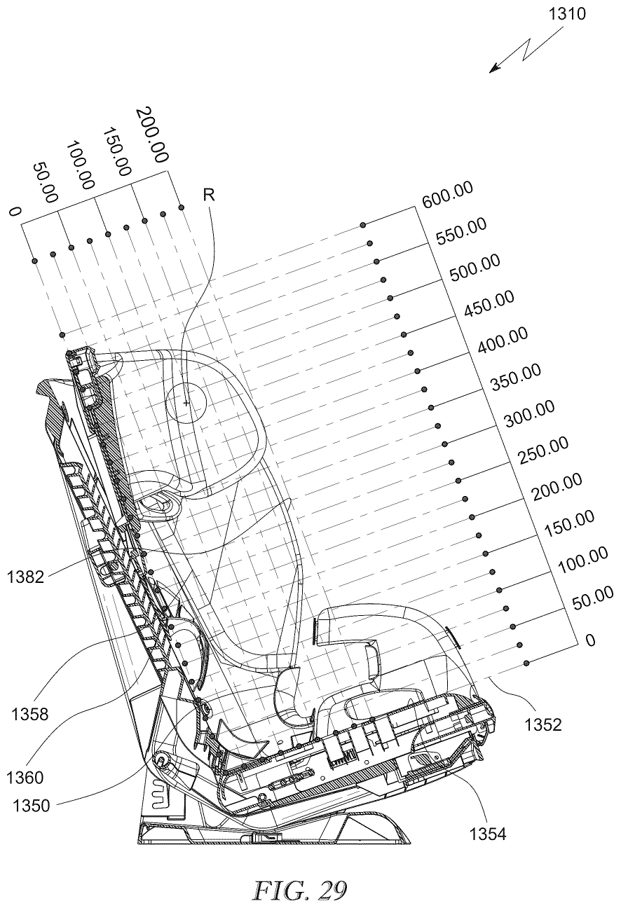

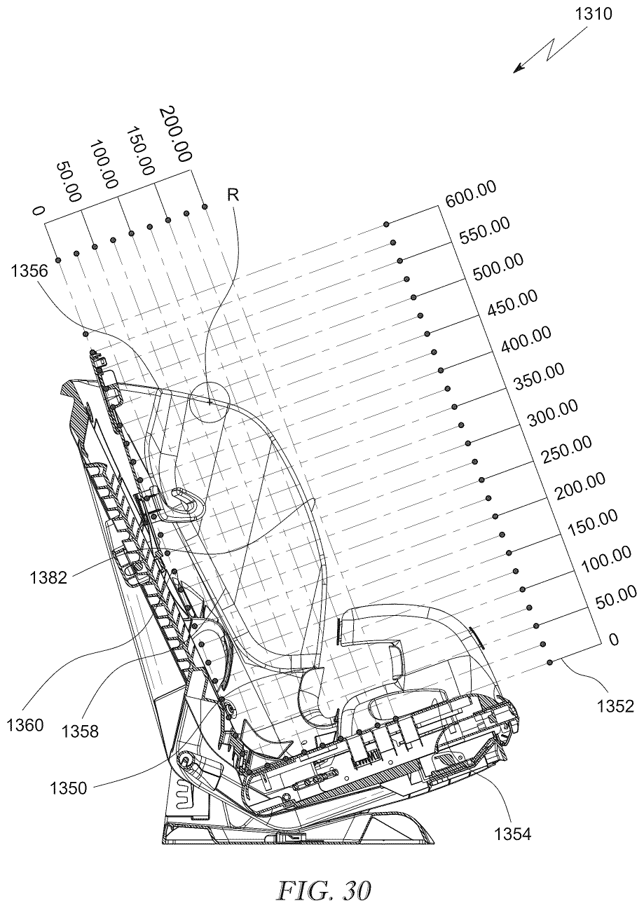

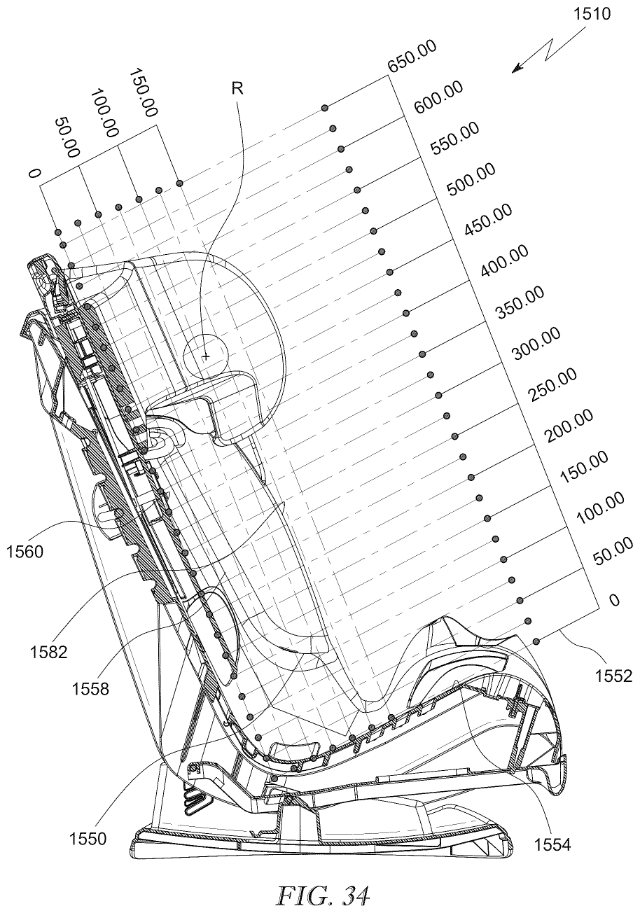

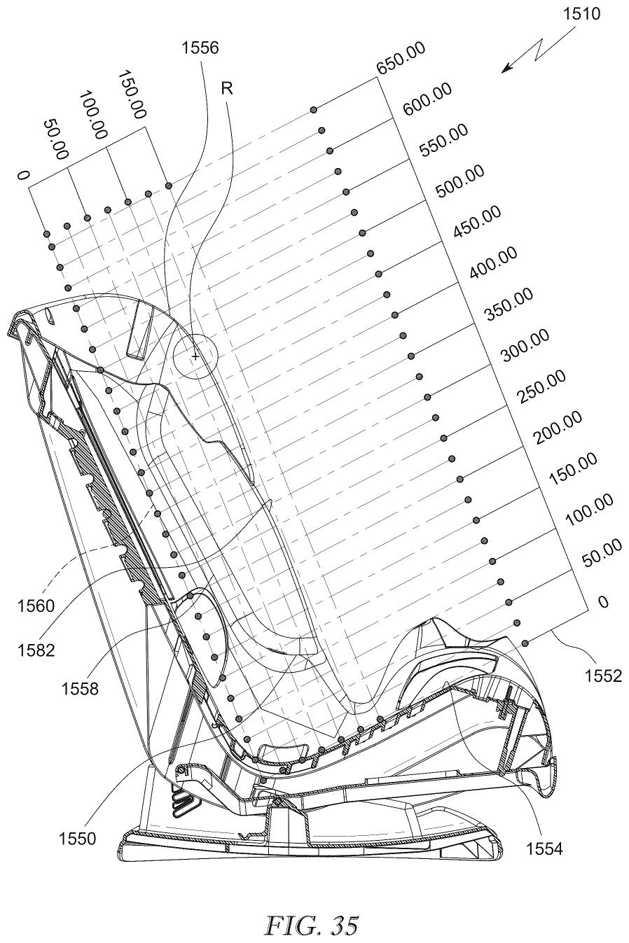

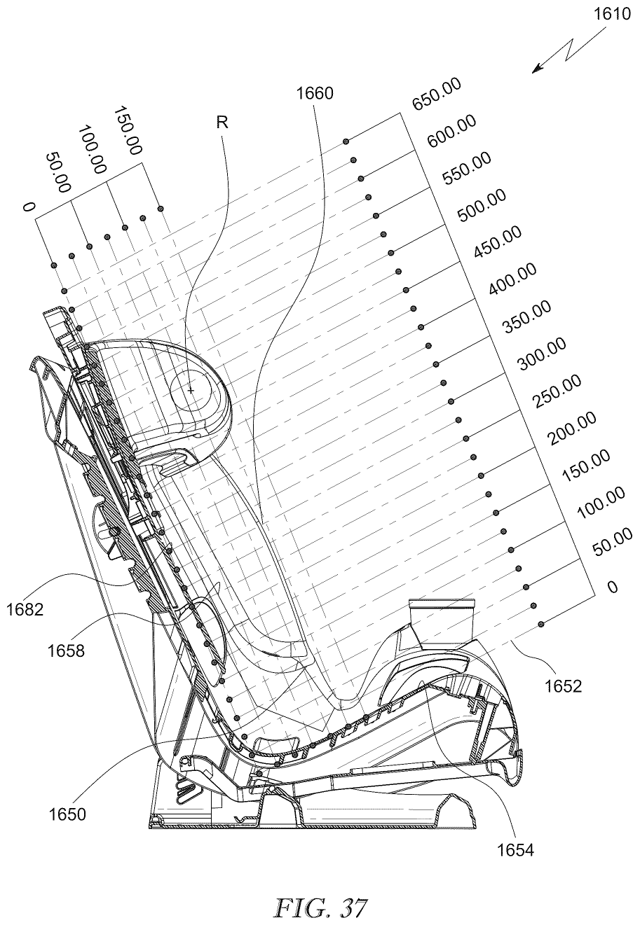

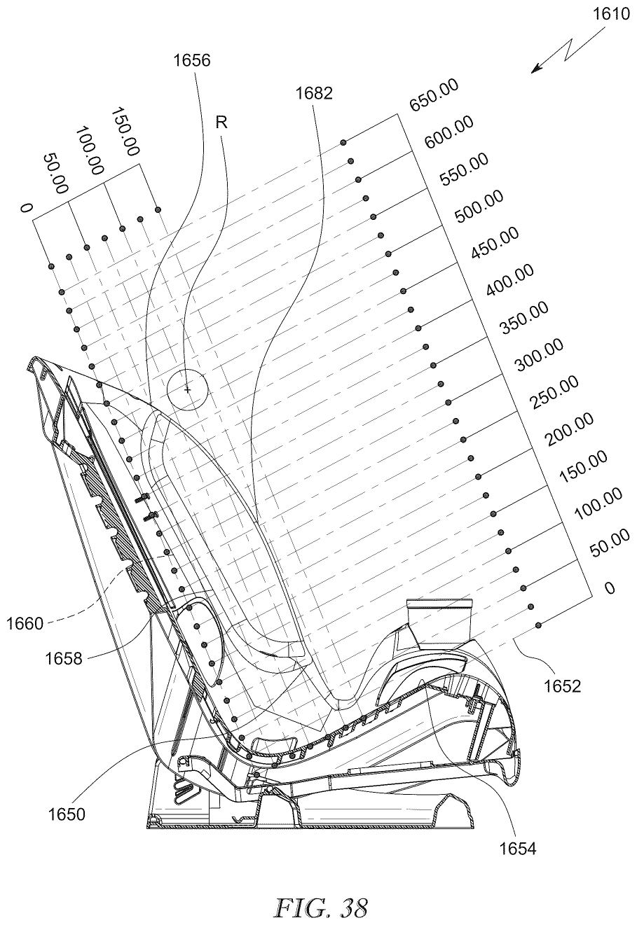

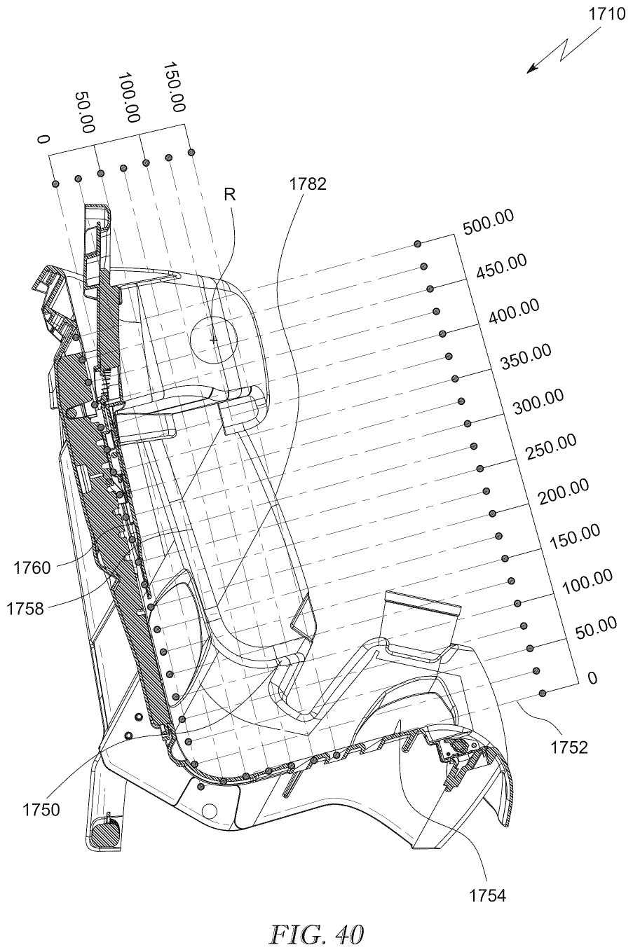

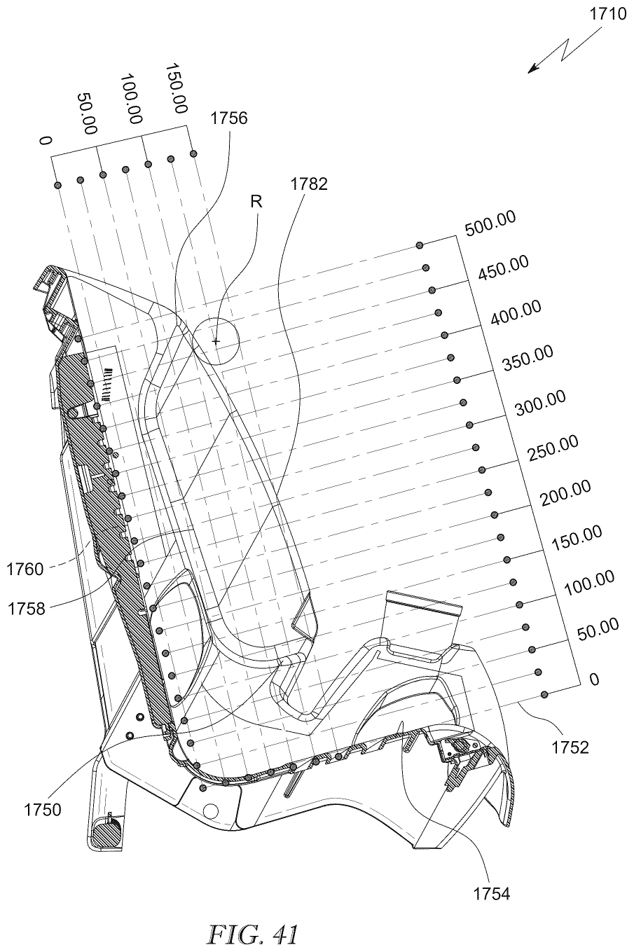

Other embodiments of child restraints similar to child restraint 10 are shown in FIGS. 6-41. The child restraints shown in FIGS. 6-41 include similar features to those described in connection with child restraint 10, such as side wings 24, 26 and recesses 28, 30 formed in the side wings 24, 26 to manage chest displacement.

FIGS. 6 and 7 show a second embodiment of a child restraint 210 including recesses 228, 230 in side wings 224, 226 of backrest 218. Child restraint 210 is substantially similar to child restraint 10. Accordingly the disclosure of child restraint 10 is hereby incorporated herein for child restraint 210.

Child restraint 210 does not include the turn-back flange 50 and instead includes a thickened side wing panel 250 partially defining the recesses 228, 230. The thickened side wing panel 250 forms the distal end of each side wing 224, 226 to reinforce the side wings 224, 226.

Child restraint 210 includes a seat shell 211 and is formed to include a child-receiving space 216 configured to hold a child for transportation in a vehicle. The seat shell 211 includes a seat bottom 212 and a seat back 214 coupled to the seat bottom 212. The seat back 214 includes a backrest 218 extending upwardly away from the seat bottom 212 and a headrest 220 coupled to the backrest 218. The seat bottom 212 and the seat back 214 at least partially define the child-receiving space 216.

In illustrative embodiments, the child restraint 210 further includes a side-impact management system 215 coupled to at least one of the seat bottom 212 and the seat back 214. The side-impact management system 215 is configured to provide means for managing chest displacement of the child during a side impact to reduce a lateral force on a shoulder region of the child during the side impact so that chest displacement of the child is minimized.

The side-impact management system 215 includes a child-restraint harness 217 coupled to the seat shell 211, a first side wing 224 coupled to a first lateral side 223 of the backrest 218 and projecting forward therefrom, and a second side wing 226 coupled to a second lateral side 225 of the backrest and projecting forward therefrom. The child-restraint harness 217 is configured to restrain the child in the child-receiving space 216. Each side wing 224, 226 is formed to include a shoulder-receiving side-impact recess 228, 230. The shoulder-receiving side-impact recess 228, 230 of the first side wing 224 or the second side wing 226 is configured to receive the shoulder and/or arm region of the child during the side impact event.

The side-impact recesses 228, 230 allow movement of the shoulder region of the child toward one of the side wings 224, 226 for a period of time during the side impact event so that the child-restraint harness 217 catches the torso of the child before the shoulder and/or arm region of the child compresses against one of the side wings 224, 226 to minimize chest displacement of the child. In other words, the child-restraint harness 217 is configured to block movement of a torso of the child relative to the seat shell 211 while the recesses 228, 230 provide spacing for the child's shoulder and arm region to move slightly during a side impact event. When the harness 217 is properly tensioned according to manufacturer instructions, the harness 217 is configured to catch the torso of the child before the child's shoulder and/or arm region engages one of the side wings 224, 226 during a side impact, thereby reducing forces on the child's shoulder and arm region and lowering chest displacement of the child.

The child restraint 210 further includes an outer trim 260 covering each shoulder-receiving side-impact recess 228, 230 of the side wings 224, 226. The outer trim 260 is spaced apart from at least a portion of each side wing 224, 226 so that each recess 228, 230 provides an empty space between the outer trim 260 and at least the portion of each side wing 224, 226. The outer trim 260 may be a flexible soft-goods or fabric. In some embodiments, the child's shoulder and/or arm regions extend into the recesses 228, 30 without contacting any rigid or force-reducing structures (e.g. relatively stiff foam, airbag, etc.). In some embodiments, the recess 228, 230 is filled at least partially with a low-density foam material or a high-rate deflateable airbag to allow movement of the child's shoulder and/or arm region quickly into the recess 228, 230 during the side impact.

Each of the side wings 224, 226 includes an upper panel or section 240, a lower panel or section 242, and a medial panel or section 244. The upper panel 240 may be a part of the backrest 218 or the headrest 220 and is configured to restrain directly or indirectly the head of the child during the side impact event. The lower panel 242 is configured to restrain a hip region of the child during the side impact event. The medial panel 244 extends between and interconnects the upper panel 240 and the lower panel 242. The recesses 228, 230 are defined below each respective upper panel 240, above each respective lower panel 242, and laterally adjacent to at least a portion of each respective medial panel 244. In other words, the medial panel 244 is formed to include the recess 228, 230 such that at least a portion of the medial panel 244 is laterally further from the child than the upper panel 240 and the lower panel 242 to provide the spacing for the child's shoulder and/or arm regions during side impacts.

The medial panel 244 may contact and support the shoulder or arm region of the child during side impacts, but the upper and lower panels 240, 242 may be configured to engage the child before the medial panel 244 during the side impact event. Instead of restraining the child's shoulder and/or arm region with the side wings 224, 226, the recesses 228, 230 allow the shoulder and/or arm region of the child to remain spaced from the side wings 224, 226 for a period of time during the side impact event so that the child is restrained primarily by the harness 217. In other words, the recesses 228, 30 provide spacing for the child's shoulder and arm region to move laterally in a first direction toward one of the side wings 224, 226, or the side wing 224, 226 to move laterally in an opposite, second direction toward the child, during the side impact event so that the harness 217 catches and restrains the torso of the child to cause a lateral force on the shoulder and arm region of the child to be reduced so that chest displacement of the child is minimized.

The medial panel 244 includes a rear segment 270 coupled to the backrest 218, a laterally-extending segment 272 coupled to the rear segment 270, and an outwardly-extending segment 274 coupled to the laterally-extending segment 272. The rear segment 270 extends away from the backrest 218 in a forward direction 271 of the child restraint 10. The laterally-extending segment 272 is coupled to a forwardmost end 273 of the rear segment 270 and extends away from the rear segment 270 in a lateral direction 275. The forward direction 271 is substantially perpendicular (i.e. between 85 degrees and 95 degrees) to the lateral direction 275. The outwardly-extending segment 274 is coupled to an outermost end 277 of the laterally-extending segment 272 and extends away from the backrest 270 in the forward direction 271. The recess 228 is defined forward of the laterally-extending segment 272 and laterally adjacent to the outwardly-extending segment 274.

In some embodiments, the rear segment 270 is formed to include a pair of belt-path apertures 276 located rearward of the recesses 228, 230. The belt-path apertures 276 may be formed entirely in the rear segment 270 of each side wing 224, 226 or partially in the rear segment 270 and partially in the backrest 218. The belt path apertures 276 extend all the way through the seat shell 211 and are configured to receive an attachment belt, such as a vehicle seat belt or a separate belt from the vehicle, to secure the child restraint 210 to the vehicle seat.

The recesses 228, 230 may provide means for allowing a shoulder region of a child seated in the child-receiving space to move into the recess during a side impact event so that impact forces experienced by the child during the side impact event are reduced. The recesses 228, 830 may provide means for satisfying federal safety standard FMVSS 213a. The recesses 228, 230 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

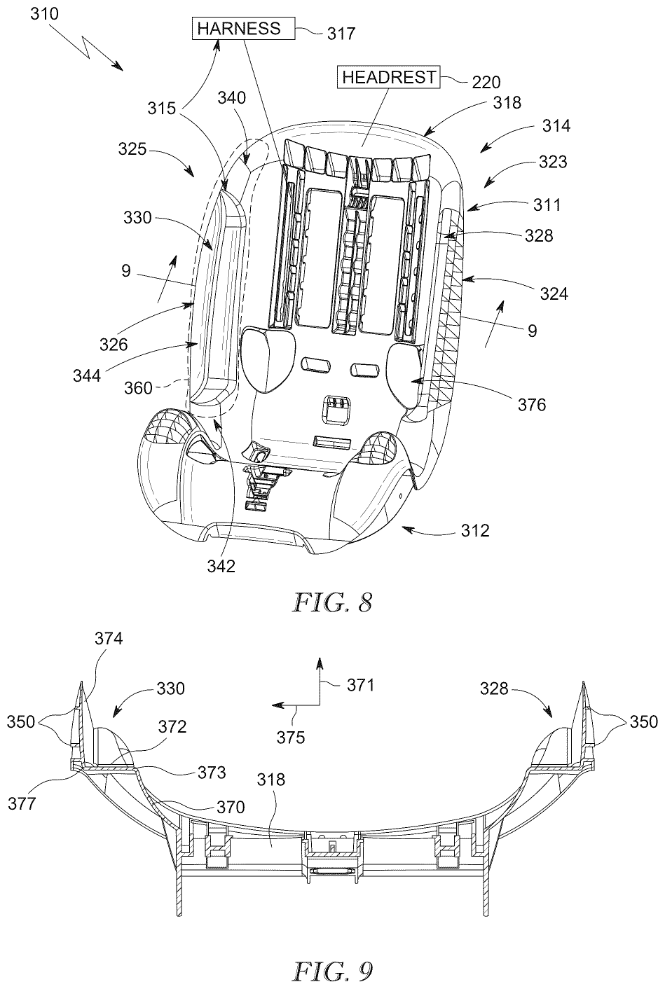

FIGS. 8 and 9 show a third embodiment of a child restraint 310 including recesses 328, 330 in side wings 324, 326 of backrest 318. Child restraint 310 is substantially similar to child restraint 10. Accordingly the disclosure of child restraint 10 is hereby incorporated herein for child restraint 310.

Child restraint 310 does not include the turn-back flange 50 and instead includes a plurality of reinforcement ribs 350 coupled to and extending outwardly away from the side wings 324, 326 in areas of the recesses 328, 330. The reinforcement ribs 350 reinforce the side wings 324, 326.

Child restraint 310 includes a seat shell 311 and is formed to include a child-receiving space 316 configured to hold a child for transportation in a vehicle. The seat shell 311 includes a seat bottom 312 and a seat back 314 coupled to the seat bottom 312. The seat back 314 includes a backrest 318 extending upwardly away from the seat bottom 312 and a headrest 320 coupled to the backrest 318. The seat bottom 312 and the seat back 314 at least partially define the child-receiving space 316.

In illustrative embodiments, the child restraint 310 further includes a side-impact management system 315 coupled to at least one of the seat bottom 312 and the seat back 314. The side-impact management system 315 is configured to provide means for managing chest displacement of the child during a side impact to reduce a lateral force on a shoulder region of the child during the side impact so that chest displacement of the child is minimized.

The side-impact management system 315 includes a child-restraint harness 317 coupled to the seat shell 311, a first side wing 324 coupled to a first lateral side 323 of the backrest 318 and projecting forward therefrom, and a second side wing 326 coupled to a second lateral side 325 of the backrest and projecting forward therefrom. The child-restraint harness 317 is configured to restrain the child in the child-receiving space 316. Each side wing 324, 326 is formed to include a shoulder-receiving side-impact recess 328, 330. The shoulder-receiving side-impact recess 328, 330 of the first side wing 324 or the second side wing 326 is configured to receive the shoulder and/or arm region of the child during the side impact event.

The side-impact recesses 328, 330 allow movement of the shoulder region of the child toward one of the side wings 324, 326 for a period of time during the side impact event so that the child-restraint harness 317 catches the torso of the child before the shoulder and/or arm region of the child compresses against one of the side wings 324, 326 to minimize chest displacement of the child. In other words, the child-restraint harness 317 is configured to block movement of a torso of the child relative to the seat shell 311 while the recesses 328, 330 provide spacing for the child's shoulder and arm region to move slightly during a side impact event. When the harness 317 is properly tensioned according to manufacturer instructions, the harness 317 is configured to catch the torso of the child before the child's shoulder and/or arm region engages one of the side wings 324, 326 during a side impact, thereby reducing forces on the child's shoulder and arm region and lowering chest displacement of the child.

The child restraint 310 further includes an outer trim 360 covering each shoulder-receiving side-impact recess 328, 330 of the side wings 324, 326. The outer trim 360 is spaced apart from at least a portion of each side wing 324, 326 so that each recess 328, 330 provides an empty space between the outer trim 360 and at least the portion of each side wing 324, 326. The outer trim 360 may be a flexible soft-goods or fabric. In some embodiments, the child's shoulder and/or arm regions extend into the recesses 328, 330 without contacting any rigid or force-reducing structures (e.g. relatively stiff foam, airbag, etc.). In some embodiments, the recess 328, 330 is filled at least partially with a low-density foam material or a high-rate deflateable airbag to allow movement of the child's shoulder and/or arm region quickly into the recess 328, 330 during the side impact.

Each of the side wings 324, 326 includes an upper panel or section 340, a lower panel or section 342, and a medial panel or section 344. The upper panel 340 may be a part of the backrest 318 or the headrest 320 and is configured to restrain directly or indirectly the head of the child during the side impact event. The lower panel 342 is configured to restrain a hip region of the child during the side impact event. The medial panel 344 extends between and interconnects the upper panel 340 and the lower panel 342. The recesses 328, 330 are defined below each respective upper panel 340, above each respective lower panel 342, and laterally adjacent to at least a portion of each respective medial panel 344. In other words, the medial panel 344 is formed to include the recess 328, 330 such that at least a portion of the medial panel 344 is laterally further from the child than the upper panel 340 and the lower panel 342 to provide the spacing for the child's shoulder and/or arm regions during side impacts.

The medial panel 344 may contact and support the shoulder or arm region of the child during side impacts, but the upper and lower panels 340, 342 may be configured to engage the child before the medial panel 344 during the side impact event. Instead of restraining the child's shoulder and/or arm region with the side wings 324, 326, the recesses 328, 330 allow the shoulder and/or arm region of the child to remain spaced from the side wings 324, 326 for a period of time during the side impact event so that the child is restrained primarily by the harness 317. In other words, the recesses 328, 30 provide spacing for the child's shoulder and arm region to move laterally in a first direction toward one of the side wings 324, 326, or the side wing 324, 326 to move laterally in an opposite, second direction toward the child, during the side impact event so that the harness 317 catches and restrains the torso of the child to cause a lateral force on the shoulder and arm region of the child to be reduced so that chest displacement of the child is minimized.

The medial panel 344 includes a rear segment 370 coupled to the backrest 318, a laterally-extending segment 372 coupled to the rear segment 370, and an outwardly-extending segment 374 coupled to the laterally-extending segment 372. The rear segment 370 extends away from the backrest 318 in a forward direction 371 of the child restraint 310. The laterally-extending segment 372 is coupled to a forwardmost end 373 of the rear segment 370 and extends away from the rear segment 370 in a lateral direction 375. The forward direction 371 is substantially perpendicular (i.e. between 85 degrees and 95 degrees) to the lateral direction 375. The outwardly-extending segment 374 is coupled to an outermost end 377 of the laterally-extending segment 372 and extends away from the backrest 370 in the forward direction 371. The recess 328 is defined forward of the laterally-extending segment 372 and laterally adjacent to the outwardly-extending segment 374.

In some embodiments, the rear segment 370 is formed to include a pair of belt-path apertures 376 located rearward of the recesses 328, 330. The belt-path apertures 376 may be formed entirely in the rear segment 370 of each side wing 324, 326 or partially in the rear segment 370 and partially in the backrest 318. The belt path apertures 376 extend all the way through the seat shell 311 and are configured to receive an attachment belt, such as a vehicle seat belt or a separate belt from the vehicle, to secure the child restraint 310 to the vehicle seat.

The recesses 328, 330 may provide means for allowing a shoulder region of a child seated in the child-receiving space to move into the recess during a side impact event so that impact forces experienced by the child during the side impact event are reduced. The recesses 328, 330 may provide means for satisfying federal safety standard FMVSS 213a. The recesses 328, 330 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

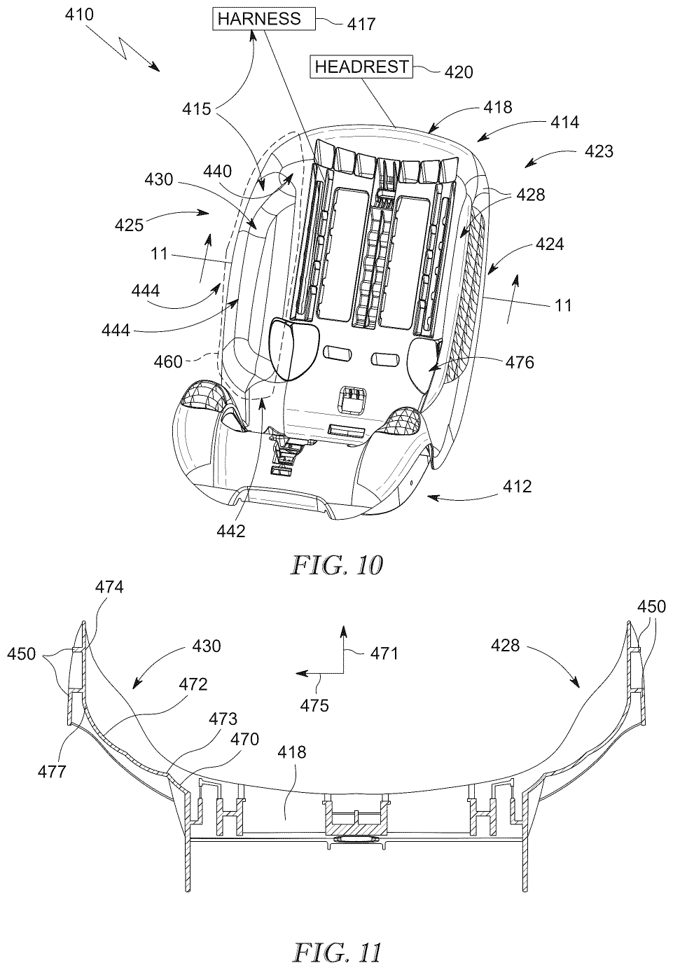

FIGS. 10 and 11 show a fourth embodiment of a child restraint 410 including recesses 428, 430 in side wings 424, 426 of backrest 418. Child restraint 410 is substantially similar to child restraint 10. Accordingly the disclosure of child restraint 10 is hereby incorporated herein for child restraint 410.

Child restraint 410 does not include the turn-back flange 50 and instead includes a plurality of reinforcement ribs 450 coupled to and extending outwardly away from the side wings 424, 426 in areas of the recesses 428, 430. The reinforcement ribs 450 reinforce the side wings 424, 426. The reinforcement ribs 450 are structured differently than ribs 350 to accommodate recesses 428, 430 that are wider and deeper than recesses 328, 330.

Child restraint 410 includes a seat shell 411 and is formed to include a child-receiving space 416 configured to hold a child for transportation in a vehicle. The seat shell 411 includes a seat bottom 412 and a seat back 414 coupled to the seat bottom 412. The seat back 414 includes a backrest 418 extending upwardly away from the seat bottom 412 and a headrest 420 coupled to the backrest 418. The seat bottom 412 and the seat back 414 at least partially define the child-receiving space 416.

In illustrative embodiments, the child restraint 410 further includes a side-impact management system 415 coupled to at least one of the seat bottom 412 and the seat back 414. The side-impact management system 415 is configured to provide means for managing chest displacement of the child during a side impact to reduce a lateral force on a shoulder region of the child during the side impact so that chest displacement of the child is minimized.

The side-impact management system 415 includes a child-restraint harness 417 coupled to the seat shell 411, a first side wing 424 coupled to a first lateral side 423 of the backrest 418 and projecting forward therefrom, and a second side wing 426 coupled to a second lateral side 425 of the backrest and projecting forward therefrom. The child-restraint harness 417 is configured to restrain the child in the child-receiving space 416. Each side wing 424, 426 is formed to include a shoulder-receiving side-impact recess 428, 430. The shoulder-receiving side-impact recess 428, 430 of the first side wing 424 or the second side wing 426 is configured to receive the shoulder and/or arm region of the child during the side impact event.

The side-impact recesses 428, 430 allow movement of the shoulder region of the child toward one of the side wings 424, 426 for a period of time during the side impact event so that the child-restraint harness 417 catches the torso of the child before the shoulder and/or arm region of the child compresses against one of the side wings 424, 426 to minimize chest displacement of the child. In other words, the child-restraint harness 417 is configured to block movement of a torso of the child relative to the seat shell 411 while the recesses 428, 430 provide spacing for the child's shoulder and arm region to move slightly during a side impact event. When the harness 417 is properly tensioned according to manufacturer instructions, the harness 417 is configured to catch the torso of the child before the child's shoulder and/or arm region engages one of the side wings 424, 426 during a side impact, thereby reducing forces on the child's shoulder and arm region and lowering chest displacement of the child.

The child restraint 410 further includes an outer trim 460 covering each shoulder-receiving side-impact recess 428, 430 of the side wings 424, 426. The outer trim 460 is spaced apart from at least a portion of each side wing 424, 426 so that each recess 428, 430 provides an empty space between the outer trim 460 and at least the portion of each side wing 424, 426. The outer trim 460 may be a flexible soft-goods or fabric. In some embodiments, the child's shoulder and/or arm regions extend into the recesses 428, 430 without contacting any rigid or force-reducing structures (e.g. relatively stiff foam, airbag, etc.). In some embodiments, the recess 428, 430 is filled at least partially with a low-density foam material or a high-rate deflateable airbag to allow movement of the child's shoulder and/or arm region quickly into the recess 428, 430 during the side impact.

Each of the side wings 424, 426 includes an upper panel or section 440, a lower panel or section 442, and a medial panel or section 444. The upper panel 440 may be a part of the backrest 418 or the headrest 420 and is configured to restrain directly or indirectly the head of the child during the side impact event. The lower panel 442 is configured to restrain a hip region of the child during the side impact event. The medial panel 444 extends between and interconnects the upper panel 440 and the lower panel 442. The recesses 428, 430 are defined below each respective upper panel 440, above each respective lower panel 442, and laterally adjacent to at least a portion of each respective medial panel 444. In other words, the medial panel 444 is formed to include the recess 428, 430 such that at least a portion of the medial panel 444 is laterally further from the child than the upper panel 440 and the lower panel 442 to provide the spacing for the child's shoulder and/or arm regions during side impacts.

The medial panel 444 may contact and support the shoulder or arm region of the child during side impacts, but the upper and lower panels 440, 442 may be configured to engage the child before the medial panel 444 during the side impact event. Instead of restraining the child's shoulder and/or arm region with the side wings 424, 426, the recesses 428, 430 allow the shoulder and/or arm region of the child to remain spaced from the side wings 424, 426 for a period of time during the side impact event so that the child is restrained primarily by the harness 417. In other words, the recesses 428, 30 provide spacing for the child's shoulder and arm region to move laterally in a first direction toward one of the side wings 424, 426, or the side wing 424, 426 to move laterally in an opposite, second direction toward the child, during the side impact event so that the harness 417 catches and restrains the torso of the child to cause a lateral force on the shoulder and arm region of the child to be reduced so that chest displacement of the child is minimized.

The medial panel 444 includes a rear segment 470 coupled to the backrest 418, a laterally-extending segment 472 coupled to the rear segment 470, and an outwardly-extending segment 474 coupled to the laterally-extending segment 472. The rear segment 470 extends away from the backrest 418 generally in a forward direction 471 of the child restraint 410. The laterally-extending segment 472 is coupled to a forwardmost end 473 of the rear segment 470 and extends away from the rear segment 470 generally in a lateral direction 475 and is concave relative to the child-receiving space 416. The forward direction 471 is substantially perpendicular (i.e. between 85 degrees and 95 degrees) to the lateral direction 475. The outwardly-extending segment 474 is coupled to an outermost end 477 of the laterally-extending segment 472 and extends away from the backrest 470 in the forward direction 471. The recess 428 is defined forward of the laterally-extending segment 472 and laterally adjacent to the outwardly-extending segment 474.

In some embodiments, the rear segment 470 is formed to include a pair of belt-path apertures 476 located rearward of the recesses 428, 430. The belt-path apertures 476 may be formed entirely in the rear segment 470 of each side wing 424, 426 or partially in the rear segment 470 and partially in the backrest 418. The belt path apertures 476 extend all the way through the seat shell 411 and are configured to receive an attachment belt, such as a vehicle seat belt or a separate belt from the vehicle, to secure the child restraint 410 to the vehicle seat.

The recesses 428, 430 may provide means for allowing a shoulder region of a child seated in the child-receiving space to move into the recess during a side impact event so that impact forces experienced by the child during the side impact event are reduced. The recesses 428, 430 may provide means for satisfying federal safety standard FMVSS 213a. The recesses 428, 430 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

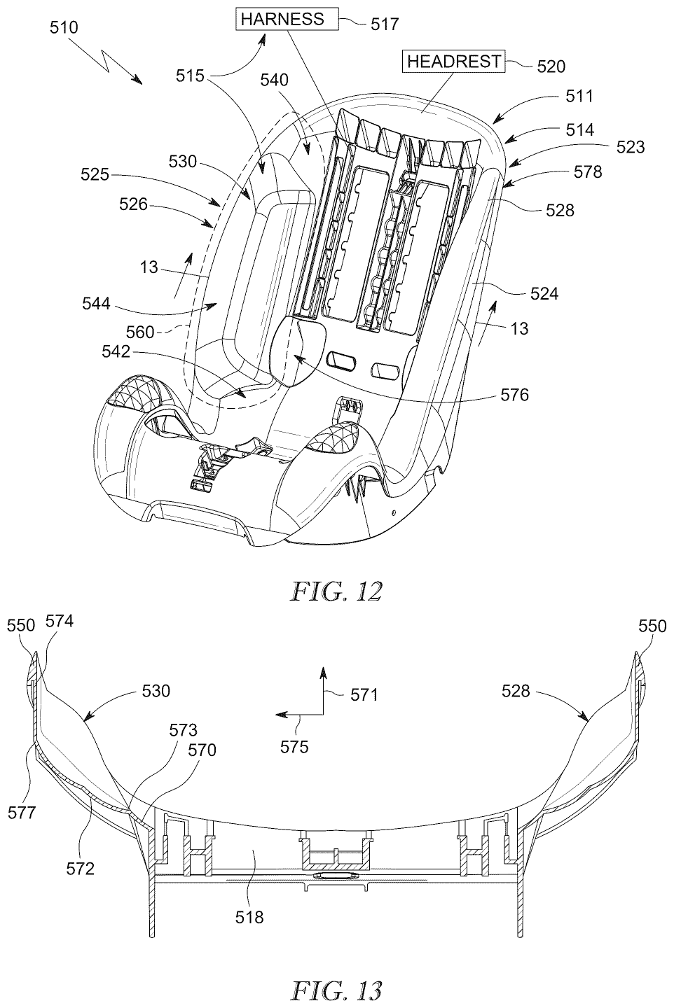

FIGS. 12 and 13 show a fifth embodiment of a child restraint 510 including recesses 528, 530 in side wings 524, 526 of backrest 518. Child restraint 510 is substantially similar to child restraint 10. Accordingly the disclosure of child restraint 10 is hereby incorporated herein for child restraint 510.

Child restraint 510 does not include the turn-back flange 50 and instead includes a thickened side wing panel 550 partially defining the recesses 528, 530. The thickened side wing panel 550 forms the distal end of each side wing 524, 526 to reinforce the side wings 524, 526. The thickened side wing panel 550 has a depth that is less that side wing panel 250.

Child restraint 510 includes a seat shell 511 and is formed to include a child-receiving space 516 configured to hold a child for transportation in a vehicle. The seat shell 511 includes a seat bottom 512 and a seat back 514 coupled to the seat bottom 512. The seat back 514 includes a backrest 518 extending upwardly away from the seat bottom 512 and a headrest 520 coupled to the backrest 518. The seat bottom 512 and the seat back 514 at least partially define the child-receiving space 516.

In illustrative embodiments, the child restraint 510 further includes a side-impact management system 515 coupled to at least one of the seat bottom 512 and the seat back 514. The side-impact management system 515 is configured to provide means for managing chest displacement of the child during a side impact to reduce a lateral force on a shoulder region of the child during the side impact so that chest displacement of the child is minimized.

The side-impact management system 515 includes a child-restraint harness 517 coupled to the seat shell 511, a first side wing 524 coupled to a first lateral side 523 of the backrest 518 and projecting forward therefrom, and a second side wing 526 coupled to a second lateral side 525 of the backrest and projecting forward therefrom. The child-restraint harness 517 is configured to restrain the child in the child-receiving space 516. Each side wing 524, 526 is formed to include a shoulder-receiving side-impact recess 528, 530. The shoulder-receiving side-impact recess 528, 530 of the first side wing 524 or the second side wing 526 is configured to receive the shoulder and/or arm region of the child during the side impact event.

The side-impact recesses 528, 530 allow movement of the shoulder region of the child toward one of the side wings 524, 526 for a period of time during the side impact event so that the child-restraint harness 517 catches the torso of the child before the shoulder and/or arm region of the child compresses against one of the side wings 524, 526 to minimize chest displacement of the child. In other words, the child-restraint harness 517 is configured to block movement of a torso of the child relative to the seat shell 511 while the recesses 528, 530 provide spacing for the child's shoulder and arm region to move slightly during a side impact event. When the harness 517 is properly tensioned according to manufacturer instructions, the harness 517 is configured to catch the torso of the child before the child's shoulder and/or arm region engages one of the side wings 524, 526 during a side impact, thereby reducing forces on the child's shoulder and arm region and lowering chest displacement of the child.

The child restraint 510 further includes an outer trim 560 covering each shoulder-receiving side-impact recess 528, 530 of the side wings 524, 526. The outer trim 560 is spaced apart from at least a portion of each side wing 524, 526 so that each recess 528, 530 provides an empty space between the outer trim 560 and at least the portion of each side wing 524, 526. The outer trim 560 may be a flexible soft-goods or fabric. In some embodiments, the child's shoulder and/or arm regions extend into the recesses 528, 530 without contacting any rigid or force-reducing structures (e.g. relatively stiff foam, airbag, etc.). In some embodiments, the recess 528, 530 is filled at least partially with a low-density foam material or a high-rate deflateable airbag to allow movement of the child's shoulder and/or arm region quickly into the recess 528, 530 during the side impact.

Each of the side wings 524, 526 includes an upper panel or section 540, a lower panel or section 542, and a medial panel or section 544. The upper panel 540 may be a part of the backrest 518 or the headrest 520 and is configured to restrain directly or indirectly the head of the child during the side impact event. The lower panel 542 is configured to restrain a hip region of the child during the side impact event. The medial panel 544 extends between and interconnects the upper panel 540 and the lower panel 542. The recesses 528, 530 are defined below each respective upper panel 540, above each respective lower panel 542, and laterally adjacent to at least a portion of each respective medial panel 544. In other words, the medial panel 544 is formed to include the recess 528, 530 such that at least a portion of the medial panel 544 is laterally further from the child than the upper panel 540 and the lower panel 542 to provide the spacing for the child's shoulder and/or arm regions during side impacts.

The medial panel 544 may contact and support the shoulder or arm region of the child during side impacts, but the upper and lower panels 540, 542 may be configured to engage the child before the medial panel 544 during the side impact event. Instead of restraining the child's shoulder and/or arm region with the side wings 524, 526, the recesses 528, 530 allow the shoulder and/or arm region of the child to remain spaced from the side wings 524, 526 for a period of time during the side impact event so that the child is restrained primarily by the harness 517. In other words, the recesses 528, 30 provide spacing for the child's shoulder and arm region to move laterally in a first direction toward one of the side wings 524, 526, or the side wing 524, 526 to move laterally in an opposite, second direction toward the child, during the side impact event so that the harness 517 catches and restrains the torso of the child to cause a lateral force on the shoulder and arm region of the child to be reduced so that chest displacement of the child is minimized.

The medial panel 544 includes a rear segment 570 coupled to the backrest 518, a laterally-extending segment 572 coupled to the rear segment 570, and an outwardly-extending segment 574 coupled to the laterally-extending segment 572. The rear segment 570 extends away from the backrest 518 in a forward direction 571 of the child restraint 510. The laterally-extending segment 572 is coupled to a forwardmost end 573 of the rear segment 570 and extends away from the rear segment 570 generally in a lateral direction 575. The laterally-extending segment 572 is concave relative to the child-receiving space 516. The forward direction 571 is substantially perpendicular (i.e. between 85 degrees and 95 degrees) to the lateral direction 575. The outwardly-extending segment 574 is coupled to an outermost end 577 of the laterally-extending segment 572 and extends away from the backrest 570 generally in the forward direction 571. The recess 528 is defined forward of the laterally-extending segment 572 and laterally adjacent to the outwardly-extending segment 574.

In some embodiments, the rear segment 570 is formed to include a pair of belt-path apertures 576 located rearward of the recesses 528, 530. The belt-path apertures 576 may be formed entirely in the rear segment 570 of each side wing 524, 526 or partially in the rear segment 570 and partially in the backrest 518. The belt path apertures 576 extend all the way through the seat shell 511 and are configured to receive an attachment belt, such as a vehicle seat belt or a separate belt from the vehicle, to secure the child restraint 510 to the vehicle seat.

The recesses 528, 530 may provide means for allowing a shoulder region of a child seated in the child-receiving space to move into the recess during a side impact event so that impact forces experienced by the child during the side impact event are reduced. The recesses 528, 530 may provide means for satisfying federal safety standard FMVSS 213a. The recesses 528, 530 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

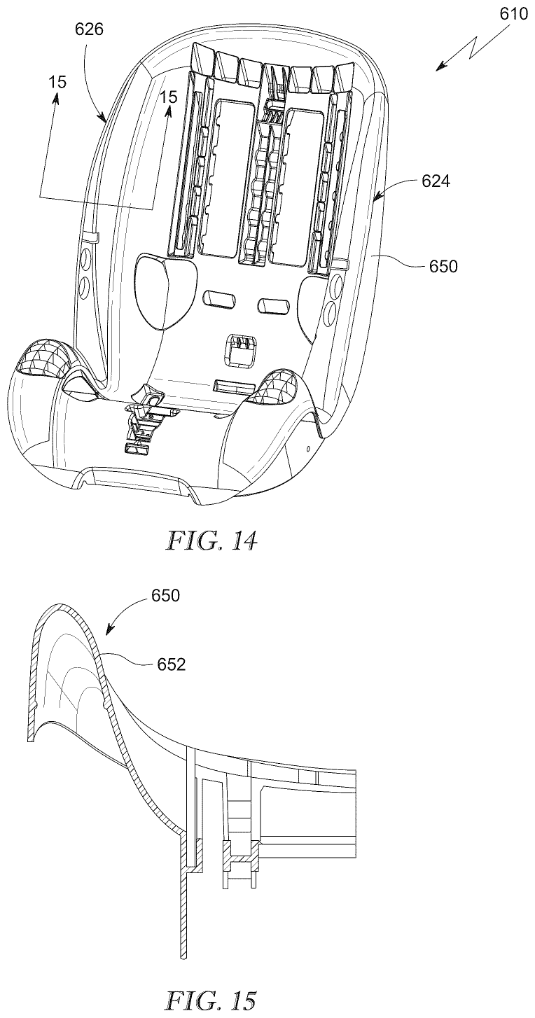

FIGS. 14 and 15 show a sixth embodiment of a child restraint 610. Child restraint 610 does not include side recesses and includes a turn-back flange 650. The turn-back flange 650 is greater in both thickness and depth than turn-back flange 50. Further and inner surface 652 of each side wing 624, 626 has no abrupt changes in shape which establish each side wing 624, 626 without a recess. Such dimensions may increase chest displacement of the child because the inner surface 652 is closer to the child in comparison to child restraints that include recesses in the side wings.

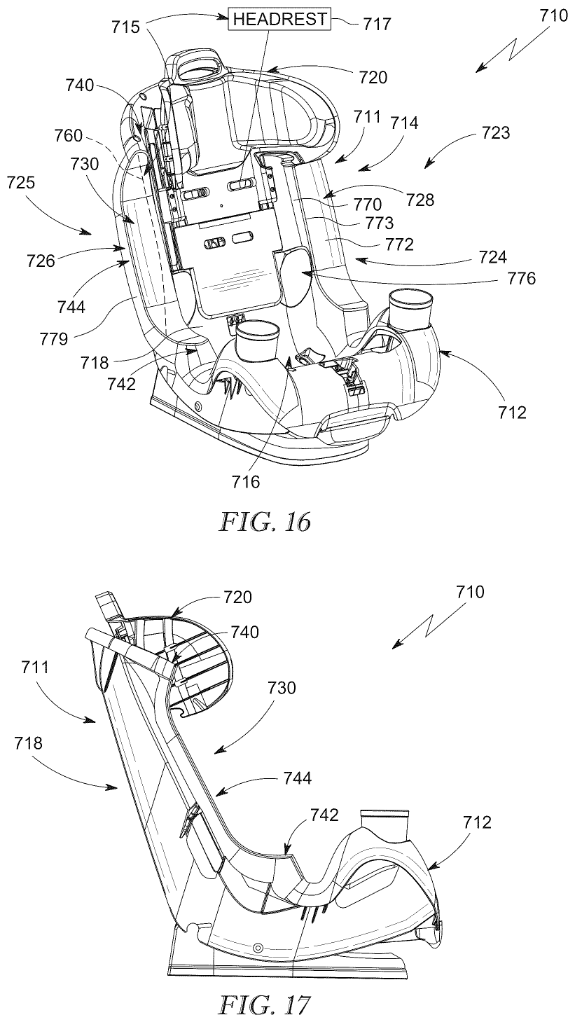

FIGS. 16 and 17 show a seventh embodiment of a child restraint 710 including recesses 728, 730 in side wings 724, 726 of backrest 718. Child restraint 710 is substantially similar to child restraint 10. Accordingly the disclosure of child restraint 10 is hereby incorporated herein for child restraint 710.

Child restraint 710 includes a seat shell 711 and is formed to include a child-receiving space 716 configured to hold a child for transportation in a vehicle. The seat shell 711 includes a seat bottom 712 and a seat back 714 coupled to the seat bottom 712. The seat back 714 includes a backrest 718 extending upwardly away from the seat bottom 712 and a headrest 720 coupled to the backrest 718. The seat bottom 712 and the seat back 714 at least partially define the child-receiving space 716. The headrest 720 is separate from the backrest 718 in this embodiment and is moveable upwardly and downwardly along the backrest 718 as the child grows.

In illustrative embodiments, the child restraint 710 further includes a side-impact management system 515 coupled to at least one of the seat bottom 712 and the seat back 714. The side-impact management system 715 is configured to provide means for managing chest displacement of the child during a side impact to reduce a lateral force on a shoulder region of the child during the side impact so that chest displacement of the child is minimized.

The side-impact management system 715 includes a child-restraint harness 717 coupled to the seat shell 711, a first side wing 724 coupled to a first lateral side 723 of the backrest 718 and projecting forward therefrom, and a second side wing 726 coupled to a second lateral side 725 of the backrest and projecting forward therefrom. The child-restraint harness 717 is configured to restrain the child in the child-receiving space 716. Each side wing 724, 726 is formed to include a shoulder-receiving side-impact recess 728, 730. The shoulder-receiving side-impact recess 728, 730 of the first side wing 724 or the second side wing 726 is configured to receive the shoulder and/or arm region of the child during the side impact event.

The side-impact recesses 728, 730 allow movement of the shoulder region of the child toward one of the side wings 724, 726 for a period of time during the side impact event so that the child-restraint harness 717 catches the torso of the child before the shoulder and/or arm region of the child compresses against one of the side wings 724, 726 to minimize chest displacement of the child. In other words, the child-restraint harness 717 is configured to block movement of a torso of the child relative to the seat shell 711 while the recesses 728, 730 provide spacing for the child's shoulder and arm region to move slightly during a side impact event. When the harness 717 is properly tensioned according to manufacturer instructions, the harness 717 is configured to catch the torso of the child before the child's shoulder and/or arm region engages one of the side wings 724, 726 during a side impact, thereby reducing forces on the child's shoulder and arm region and lowering chest displacement of the child.

Each of the side wings 724, 726 includes an upper panel or section 740, a lower panel or section 742, and a medial panel or section 744. The upper panel 740 may be a part of the backrest 718 or the headrest 720 and is configured to restrain directly or indirectly the head of the child during the side impact event. In other words, the headrest 720 may act as the upper panel 740, particularly when the child is smaller and the headrest 720 is lowered closer to the seat bottom 712. The lower panel 742 is configured to restrain a hip region of the child during the side impact event. The medial panel 744 extends between and interconnects the upper panel 740 and the lower panel 742. The recesses 728, 730 are defined below each respective upper panel 740, above each respective lower panel 742, and adjacent to at least a portion of each respective medial panel 744. In other words, the medial panel 744 is formed to include the recess 728, 730 to provide the spacing for the child's shoulder and/or arm regions during side impacts.

The medial panel 744 may contact and support the shoulder or arm region of the child during side impacts, but the upper and lower panels 740, 742 may be configured to engage the child before the medial panel 744 during the side impact event. Instead of restraining the child's shoulder and/or arm region with the side wings 724, 726, the recesses 728, 730 allow the shoulder and/or arm region of the child to remain spaced from the side wings 724, 726 for a period of time during the side impact event so that the child is restrained primarily by the harness 717. In other words, the recesses 728, 30 provide spacing for the child's shoulder and arm region to move laterally in a first direction toward one of the side wings 724, 726, or the side wing 724, 726 to move laterally in an opposite, second direction toward the child, during the side impact event so that the harness 717 catches and restrains the torso of the child to cause a lateral force on the shoulder and arm region of the child to be reduced so that chest displacement of the child is minimized.

The medial panel 744 includes a rear segment 770 coupled to the backrest 718, a laterally-extending segment 772 coupled to the rear segment 770, and a turn-back flange 779 coupled to the laterally-extending segment 772 as shown in FIGS. 16 and 17. The rear segment 770 extends away from the backrest 718 in a forward direction of the child restraint 710. The laterally-extending segment 772 is coupled to a forwardmost end 773 of the rear segment 770 and extends away from the rear segment 770 in a lateral direction. The forward direction is substantially perpendicular (i.e. between 85 degrees and 95 degrees) to the lateral direction. The turn-back flange 779 is coupled to a distal end of the laterally-extending segment 772 and extends in a rearward direction opposite direction. The recess 728 is defined forward of the laterally-extending segment 772. In other words, the recesses 728, 730 are unbounded in the lateral direction to derestrict movement of the shoulder and/or arm region of the child in the lateral direction 775 during the side impact event. The rear segment 770 is formed to include a belt-path aperture 776 located rearward of the recesses 728, 730.

The recesses 728, 730 may provide means for allowing a shoulder region of a child seated in the child-receiving space to move into the recess during a side impact event so that impact forces experienced by the child during the side impact event are reduced. The recesses 728, 730 may provide means for satisfying federal safety standard FMVSS 213a. The recesses 728, 730 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

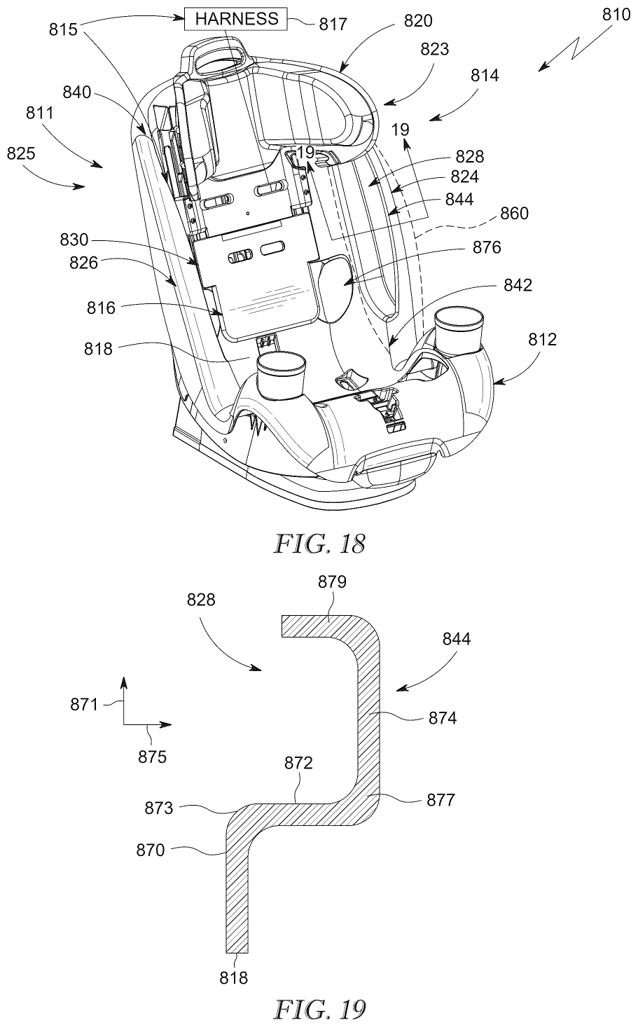

FIGS. 18 and 19 show an eighth embodiment of a child restraint 810 including recesses 828, 830 in side wings 824, 826 of backrest 818. Child restraint 810 is substantially similar to child restraint 10. Accordingly the disclosure of child restraint 10 is hereby incorporated herein for child restraint 810.

Child restraint 810 includes a seat shell 811 and is formed to include a child-receiving space 816 configured to hold a child for transportation in a vehicle. The seat shell 811 includes a seat bottom 812 and a seat back 814 coupled to the seat bottom 812. The seat back 814 includes a backrest 818 extending upwardly away from the seat bottom 812 and a headrest 820 coupled to the backrest 818. The seat bottom 812 and the seat back 814 at least partially define the child-receiving space 816.

In illustrative embodiments, the child restraint 810 further includes a side-impact management system 815 coupled to at least one of the seat bottom 812 and the seat back 814. The side-impact management system 815 is configured to provide means for managing chest displacement of the child during a side impact to reduce a lateral force on a shoulder region of the child during the side impact so that chest displacement of the child is minimized.

The side-impact management system 815 includes a child-restraint harness 817 coupled to the seat shell 811, a first side wing 824 coupled to a first lateral side 823 of the backrest 818 and projecting forward therefrom, and a second side wing 826 coupled to a second lateral side 825 of the backrest and projecting forward therefrom. The child-restraint harness 817 is configured to restrain the child in the child-receiving space 816. Each side wing 824, 826 is formed to include a shoulder-receiving side-impact recess 828, 830. The shoulder-receiving side-impact recess 828, 830 of the first side wing 824 or the second side wing 826 is configured to receive the shoulder and/or arm region of the child during the side impact event.

The side-impact recesses 828, 830 allow movement of the shoulder region of the child toward one of the side wings 824, 826 for a period of time during the side impact event so that the child-restraint harness 817 catches the torso of the child before the shoulder and/or arm region of the child compresses against one of the side wings 824, 826 to minimize chest displacement of the child. In other words, the child-restraint harness 817 is configured to block movement of a torso of the child relative to the seat shell 811 while the recesses 828, 830 provide spacing for the child's shoulder and arm region to move slightly during a side impact event. When the harness 817 is properly tensioned according to manufacturer instructions, the harness 817 is configured to catch the torso of the child before the child's shoulder and/or arm region engages one of the side wings 824, 826 during a side impact, thereby reducing forces on the child's shoulder and arm region and lowering chest displacement of the child.

The child restraint 810 further includes an outer trim 860 covering each shoulder-receiving side-impact recess 828, 830 of the side wings 824, 826. The outer trim 860 is spaced apart from at least a portion of each side wing 824, 826 so that each recess 828, 830 provides an empty space between the outer trim 860 and at least the portion of each side wing 824, 826. The outer trim 860 may be a flexible soft-goods or fabric. In some embodiments, the child's shoulder and/or arm regions extend into the recesses 828, 830 without contacting any rigid or force-reducing structures (e.g. relatively stiff foam, airbag, etc.). In some embodiments, the recess 828, 830 is filled at least partially with a low-density foam material or a high-rate deflateable airbag to allow movement of the child's shoulder and/or arm region quickly into the recess 828, 830 during the side impact.

Each of the side wings 824, 826 includes an upper panel or section 840, a lower panel or section 842, and a medial panel or section 844. The upper panel 840 may be a part of the backrest 818 or the headrest 820 and is configured to restrain the head of the child during the side impact event. The lower panel 842 is configured to restrain a hip region of the child during the side impact event. The medial panel 844 extends between and interconnects the upper panel 840 and the lower panel 842. The recesses 828, 830 are defined below each respective upper panel 840, above each respective lower panel 842, and laterally adjacent to at least a portion of each respective medial panel 844. In other words, the medial panel 844 is formed to include the recess 828, 830 such that at least a portion of the medial panel 844 is laterally further from the child than the upper panel 840 and the lower panel 842 to provide the spacing for the child's shoulder and/or arm regions during side impacts.

The medial panel 844 may contact and support the shoulder or arm region of the child during side impacts, but the upper and lower panels 840, 842 may be configured to engage the child before the medial panel 844 during the side impact event. Instead of restraining the child's shoulder and/or arm region with the side wings 824, 826, the recesses 828, 830 allow the shoulder and/or arm region of the child to remain spaced from the side wings 824, 826 for a period of time during the side impact event so that the child is restrained primarily by the harness 817. In other words, the recesses 828, 30 provide spacing for the child's shoulder and arm region to move laterally in a first direction toward one of the side wings 824, 826, or the side wing 824, 826 to move laterally in an opposite, second direction toward the child, during the side impact event so that the harness 817 catches and restrains the torso of the child to cause a lateral force on the shoulder and arm region of the child to be reduced so that chest displacement of the child is minimized.

The medial panel 844 includes a rear segment 870 coupled to the backrest 818, a laterally-extending segment 872 coupled to the rear segment 870, an outwardly-extending segment 874 coupled to the laterally-extending segment 872, and a turn-back flange 879 coupled to the outwardly-extending segment 874 as shown in FIGS. 18 and 19. The rear segment 870 extends away from the backrest 818 in a forward direction 871 of the child restraint 810. The laterally-extending segment 872 is coupled to a forwardmost end 873 of the rear segment 870 and extends away from the rear segment 870 in a lateral direction 875. The forward direction 871 is substantially perpendicular (i.e. between 85 degrees and 95 degrees) to the lateral direction 875. The outwardly-extending segment 874 is coupled to an outermost end 877 of the laterally-extending segment 872 and extends away from the backrest 818 in the forward direction 871. The turn-back flange 879 is coupled to a distal end of the outwardly-extending segment 874 and extends in the a lateral direction opposite direction 875. The recess 828 is defined forward of the laterally-extending segment 872, laterally adjacent to the outwardly-extending segment 874, and rearward of the turn-back flange 879. The rear segment 870 is formed to include a belt-path aperture 876 located rearward of the recesses 828, 830.

The recesses 828, 830 may provide means for allowing a shoulder region of a child seated in the child-receiving space to move into the recess during a side impact event so that impact forces experienced by the child during the side impact event are reduced. The recesses 828, 830 may provide means for satisfying federal safety standard FMVSS 213a. The recesses 828, 830 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

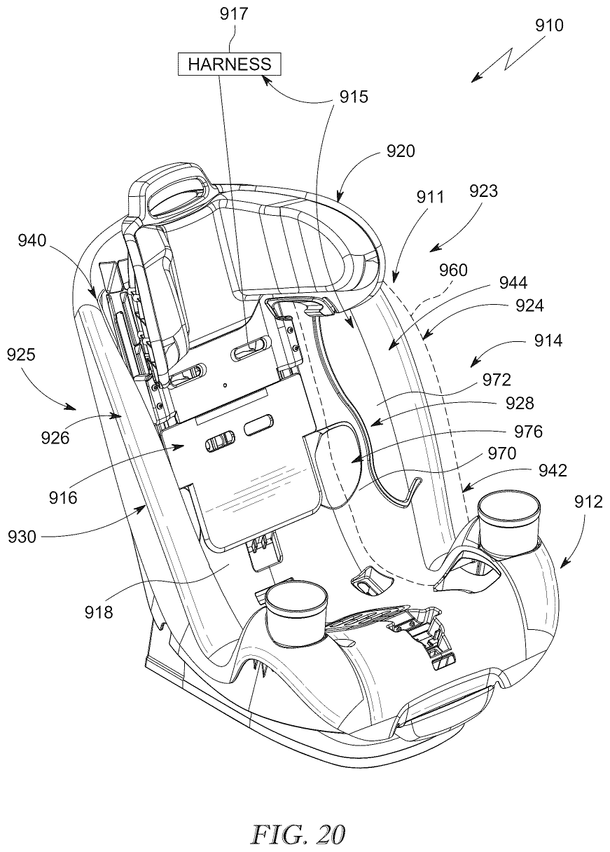

FIG. 20 shows a nineth embodiment of a child restraint 910 including recesses 928, 930 in side wings 924, 926 of backrest 918. Child restraint 910 is substantially similar to child restraint 10. Accordingly the disclosure of child restraint 10 is hereby incorporated herein for child restraint 910.

Child restraint 910 includes a seat shell 911 and is formed to include a child-receiving space 916 configured to hold a child for transportation in a vehicle. The seat shell 911 includes a seat bottom 912 and a seat back 914 coupled to the seat bottom 912. The seat back 914 includes a backrest 918 extending upwardly away from the seat bottom 912 and a headrest 920 coupled to the backrest 918. The seat bottom 912 and the seat back 914 at least partially define the child-receiving space 916.

In illustrative embodiments, the child restraint 910 further includes a side-impact management system 915 coupled to at least one of the seat bottom 912 and the seat back 914. The side-impact management system 915 is configured to provide means for managing chest displacement of the child during a side impact to reduce a lateral force on a shoulder region of the child during the side impact so that chest displacement of the child is minimized.

The side-impact management system 915 includes a child-restraint harness 917 coupled to the seat shell 911, a first side wing 924 coupled to a first lateral side 923 of the backrest 918 and projecting forward therefrom, and a second side wing 926 coupled to a second lateral side 925 of the backrest and projecting forward therefrom. The child-restraint harness 917 is configured to restrain the child in the child-receiving space 916. Each side wing 924, 926 is formed to include a shoulder-receiving side-impact recess 928, 930. The shoulder-receiving side-impact recess 928, 930 of the first side wing 924 or the second side wing 926 is configured to receive the shoulder and/or arm region of the child during the side impact event.

The side-impact recesses 928, 930 allow movement of the shoulder region of the child toward one of the side wings 924, 926 for a period of time during the side impact event so that the child-restraint harness 917 catches the torso of the child before the shoulder and/or arm region of the child compresses against one of the side wings 924, 926 to minimize chest displacement of the child. In other words, the child-restraint harness 917 is configured to block movement of a torso of the child relative to the seat shell 911 while the recesses 928, 930 provide spacing for the child's shoulder and arm region to move slightly during a side impact event. When the harness 917 is properly tensioned according to manufacturer instructions, the harness 917 is configured to catch the torso of the child before the child's shoulder and/or arm region engages one of the side wings 924, 926 during a side impact, thereby reducing forces on the child's shoulder and arm region and lowering chest displacement of the child.

The child restraint 910 further includes an outer trim 960 covering each shoulder-receiving side-impact recess 928, 930 of the side wings 924, 926. The outer trim 960 is spaced apart from at least a portion of each side wing 924, 926 so that each recess 928, 930 provides an empty space between the outer trim 960 and at least the portion of each side wing 924, 926. The outer trim 960 may be a flexible soft-goods or fabric. In some embodiments, the child's shoulder and/or arm regions extend into the recesses 928, 930 without contacting any rigid or force-reducing structures (e.g. relatively stiff foam, airbag, etc.). In some embodiments, the recess 928, 930 is filled at least partially with a low-density foam material or a high-rate deflateable airbag to allow movement of the child's shoulder and/or arm region quickly into the recess 928, 930 during the side impact.

Each of the side wings 924, 926 includes an upper panel or section 940, a lower panel or section 942, and a medial panel or section 944. The upper panel 940 may be a part of the backrest 918 or the headrest 920 and is configured to restrain the head of the child during the side impact event. The lower panel 942 is configured to restrain a hip region of the child during the side impact event. The medial panel 944 extends between and interconnects the upper panel 940 and the lower panel 942. The recesses 928, 930 are defined below each respective upper panel 940, above each respective lower panel 942, and adjacent to at least a portion of each respective medial panel 944. In other words, the medial panel 944 is formed to include the recess 928, 930 to allow for the child's shoulder and/or arm regions to move laterally during side impacts.

The medial panel 944 may contact and support the shoulder or arm region of the child during side impacts, but the upper and lower panels 940, 942 may be configured to engage the child before the medial panel 944 during the side impact event. Instead of restraining the child's shoulder and/or arm region with the side wings 924, 926, the recesses 928, 930 allow the shoulder and/or arm region of the child to remain spaced from the side wings 924, 926 for a period of time during the side impact event so that the child is restrained primarily by the harness 917. In other words, the recesses 928, 930 provide spacing for the child's shoulder and arm region to move laterally in a first direction toward one of the side wings 924, 926, or the side wing 924, 926 to move laterally in an opposite, second direction toward the child, during the side impact event so that the harness 917 catches and restrains the torso of the child to cause a lateral force on the shoulder and arm region of the child to be reduced so that chest displacement of the child is minimized.

The recesses 928, 930 are formed as slots in the medial panel 944 to allow deformation of a portion of the medial panel 944 relative to the upper and lower panels 940, 942 during a side impact event as the child's shoulder and/or arm region contacts the medial panel 944. The medial panel 944 includes a rear segment 970 coupled to the backrest 918 and a movable panel 972 partially spaced apart from the rear segment 970 and movable relative to the rear segment 970. The rear segment 970 is also formed to include a belt path aperture 976 located rearward of the recesses 928, 930 and having a smaller height in comparison to the recesses 928, 930.

The recesses 928, 930 may provide means for allowing a shoulder region of a child seated in the child-receiving space to move into the recess during a side impact event so that impact forces experienced by the child during the side impact event are reduced. The recesses 928, 930 may provide means for satisfying federal safety standard FMVSS 213a. The recesses 928, 930 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

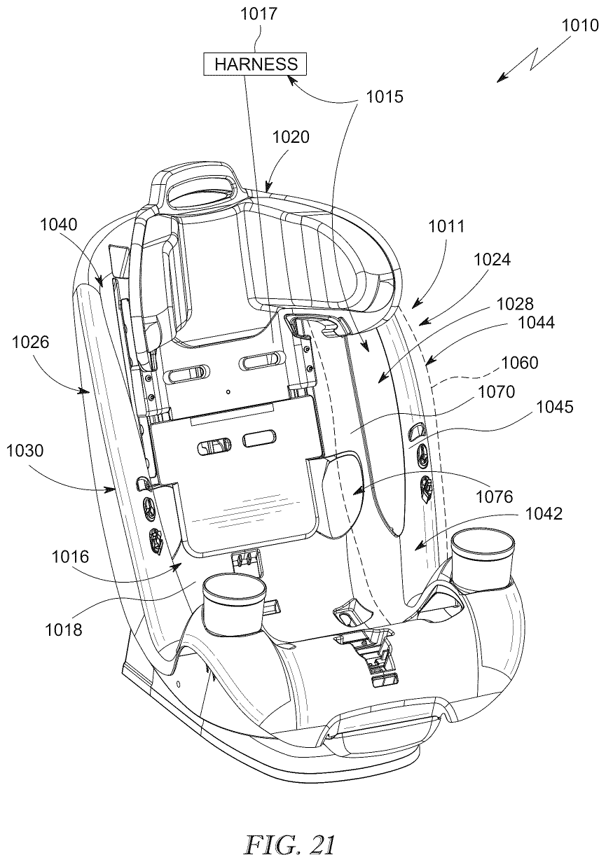

FIG. 21 shows a tenth embodiment of a child restraint 1010 including recesses 10928, 1030 in side wings 1024, 1026 of backrest 1018. Child restraint 1010 is substantially similar to child restraint 10. Accordingly the disclosure of child restraint 10 is hereby incorporated herein for child restraint 1010.

Child restraint 1010 includes a seat shell 1011 and is formed to include a child-receiving space 1016 configured to hold a child for transportation in a vehicle. The seat shell 1011 includes a seat bottom 1012 and a seat back 1014 coupled to the seat bottom 1012. The seat back 1014 includes a backrest 1018 extending upwardly away from the seat bottom 1012 and a headrest 1020 coupled to the backrest 1018. The seat bottom 1012 and the seat back 1014 at least partially define the child-receiving space 1016.

In illustrative embodiments, the child restraint 1010 further includes a side-impact management system 1015 coupled to at least one of the seat bottom 1012 and the seat back 1014. The side-impact management system 1015 is configured to provide means for managing chest displacement of the child during a side impact to reduce a lateral force on a shoulder region of the child during the side impact so that chest displacement of the child is minimized.

The side-impact management system 1015 includes a child-restraint harness 1017 coupled to the seat shell 1011, a first side wing 1024 coupled to a first lateral side 1023 of the backrest 1018 and projecting forward therefrom, and a second side wing 1026 coupled to a second lateral side 1025 of the backrest and projecting forward therefrom. The child-restraint harness 1017 is configured to restrain the child in the child-receiving space 1016. Each side wing 1024, 1026 is formed to include a shoulder-receiving side-impact recess 1028, 1030. The shoulder-receiving side-impact recess 1028, 1030 of the first side wing 1024 or the second side wing 1026 is configured to receive the shoulder and/or arm region of the child during the side impact event.

The side-impact recesses 1028, 1030 allow movement of the shoulder region of the child toward one of the side wings 1024, 1026 for a period of time during the side impact event so that the child-restraint harness 1017 catches the torso of the child before the shoulder and/or arm region of the child compresses against one of the side wings 1024, 1026 to minimize chest displacement of the child. In other words, the child-restraint harness 1017 is configured to block movement of a torso of the child relative to the seat shell 1011 while the recesses 1028, 1030 provide spacing for the child's shoulder and arm region to move slightly during a side impact event. When the harness 1017 is properly tensioned according to manufacturer instructions, the harness 1017 is configured to catch the torso of the child before the child's shoulder and/or arm region engages one of the side wings 1024, 1026 during a side impact, thereby reducing forces on the child's shoulder and arm region and lowering chest displacement of the child.

The child restraint 1010 further includes an outer trim 1060 covering each shoulder-receiving side-impact recess 1028, 1030 of the side wings 1024, 1026. The outer trim 1060 is spaced apart from at least a portion of each side wing 1024, 1026 so that each recess 1028, 1030 provides an empty space between the outer trim 1060 and at least the portion of each side wing 1024, 1026. The outer trim 1060 may be a flexible soft-goods or fabric. In some embodiments, the child's shoulder and/or arm regions extend into the recesses 1028, 1030 without contacting any rigid or force-reducing structures (e.g. relatively stiff foam, airbag, etc.). In some embodiments, the recess 1028, 1030 is filled at least partially with a low-density foam material or a high-rate deflateable airbag to allow movement of the child's shoulder and/or arm region quickly into the recess 1028, 1030 during the side impact.

Each of the side wings 1024, 1026 includes an upper panel or section 1040, a lower panel or section 1042, and a medial panel or section 1044. The upper panel 1040 may be a part of the backrest 1018 or the headrest 1020 and is configured to restrain the head of the child during the side impact event. The lower panel 1042 is configured to restrain a hip region of the child during the side impact event. The medial panel 1044 extends between and interconnects the upper panel 1040 and the lower panel 1042. The recesses 1028, 1030 are defined below each respective upper panel 1040, above each respective lower panel 1042, and adjacent to at least a portion of each respective medial panel 1044. In other words, the medial panel 1044 is formed to include the recess 1028, 1030 to allow for the child's shoulder and/or arm regions to move laterally during side impacts.

The medial panel 1044 may contact and support the shoulder or arm region of the child during side impacts, but the upper and lower panels 1040, 1042 may be configured to engage the child before the medial panel 1044 during the side impact event. Instead of restraining the child's shoulder and/or arm region with the side wings 1024, 1026, the recesses 1028, 1030 allow the shoulder and/or arm region of the child to remain spaced from the side wings 1024, 1026 for a period of time during the side impact event so that the child is restrained primarily by the harness 1017. In other words, the recesses 1028, 1030 provide spacing for the child's shoulder and arm region to move laterally in a first direction toward one of the side wings 1024, 1026, or the side wing 1024, 1026 to move laterally in an opposite, second direction toward the child, during the side impact event so that the harness 1017 catches and restrains the torso of the child to cause a lateral force on the shoulder and arm region of the child to be reduced so that chest displacement of the child is minimized.

The recesses 1028, 1030 extend all the way through the medial panel 1044 in the illustrative embodiment. In other words, the recesses 1028, 1030 are unbounded in a lateral direction to derestrict movement of the shoulder and/or arm region of the child in the lateral direction during the side impact event. The medial panel 1044 includes a rear segment 1070 coupled to the backrest 1018 and a bridge 1045 extending between the upper panel 1040 and the lower panel 1042 and spaced apart from the rear segment 1070 in a forward direction to provide the recesses 1028, 1030 therebetween. The recesses 1028, 1030 have an upper extent below a top end of the seat back 14, a lower extent above a seat-pan seating surface of the seat bottom 12, and an unbounded lateral extent between an inner edge of each respective side wing and an outer edge of each respective side wing. The rear segment 1070 is also formed to include a belt path aperture 1076 located rearward of the recesses 1028, 1030 and having a smaller height in comparison to the recesses 1028, 1030.

The recesses 1028, 1030 may provide means for allowing a shoulder region of a child seated in the child-receiving space to move into the recess during a side impact event so that impact forces experienced by the child during the side impact event are reduced. The recesses 1028, 1030 may provide means for satisfying federal safety standard FMVSS 213a. The recesses 1028, 1030 may provide means for unrestricting a shoulder region of a child seated in the child-receiving space as either of the side walls moves laterally toward the shoulder region of the child during a side impact event to cause the shoulder region of the child to move into the recess without contacting the seat back so that forces experienced by the child during the side impact event are transferred to a harness.

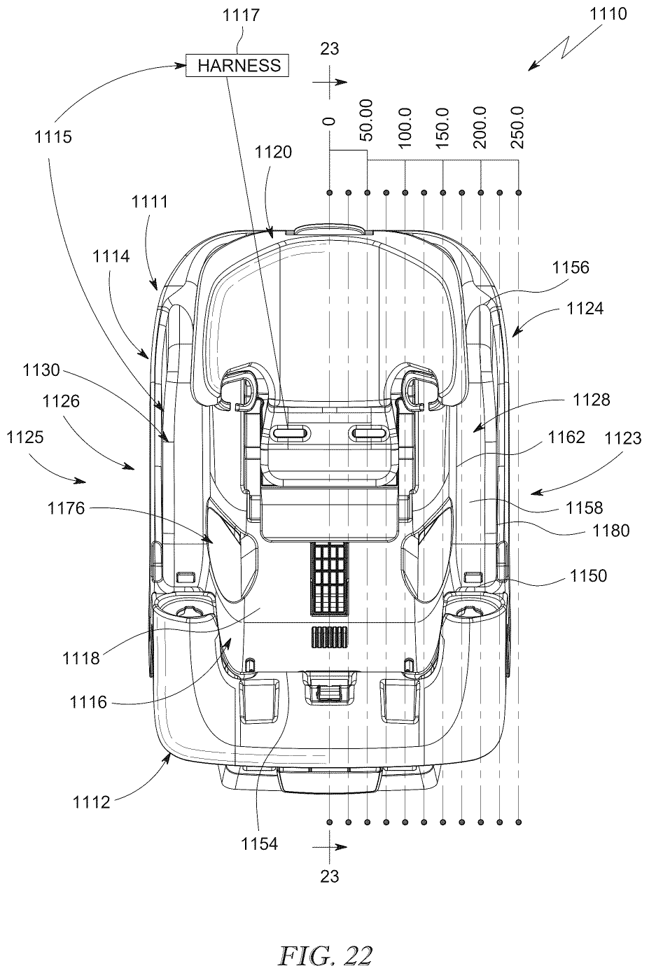

FIGS. 22-41 show additional examples of child restraints including side wings with recesses formed in the side wings to manage chest displacement of a child. Each of FIGS. 22-41 is draw to scale and scales are shown in each figure. All values shown in the scales are in millimeters (mm).

FIGS. 22-24 show a eleventh embodiment of a child restraint 1110 including recesses 1128, 1130 in side wings 1124, 1126 of backrest 1118. Child restraint 1110 is substantially similar to child restraint 10. Accordingly the disclosure of child restraint 10 is hereby incorporated herein for child restraint 1110.

Child restraint 1110 includes a seat shell 1111 and is formed to include a child-receiving space 1116 configured to hold a child for transportation in a vehicle. The seat shell 1111 includes a seat bottom 1112 and a seat back 1114 coupled to the seat bottom 1112. The seat back 1114 includes a backrest 1118 extending upwardly away from the seat bottom 1112 and a headrest 1120 coupled to the backrest 1118. The seat bottom 1112 and the seat back 1114 at least partially define the child-receiving space 1116.

In illustrative embodiments, the child restraint 1110 further includes a side-impact management system 1115 coupled to at least one of the seat bottom 1112 and the seat back 1114. The side-impact management system 1115 is configured to provide means for managing chest displacement of the child during a side impact to reduce a lateral force on a shoulder region of the child during the side impact so that chest displacement of the child is minimized.

The side-impact management system 1115 includes a child-restraint harness 1117 coupled to the seat shell 1111, a first side wing 1124 coupled to a first lateral side 1123 of the backrest 1118 and projecting forward therefrom, and a second side wing 1126 coupled to a second lateral side 1125 of the backrest and projecting forward therefrom. The child-restraint harness 1117 is configured to restrain the child in the child-receiving space 1116. Each side wing 1124, 1126 is formed to include a shoulder-receiving side-impact recess 1128, 1130. The shoulder-receiving side-impact recess 1128, 1130 of the first side wing 1124 or the second side wing 1126 is configured to receive the shoulder and/or arm region of the child during the side impact event.

A lowermost end 1150 of the recess 1128, 1130 is located within 125 mm of a seat bottom plane 1152 established by a seating surface 1154 of the seat bottom 1112. In some embodiments, the lowermost end 1150 of the recess 1128, 1130 is located within 115 mm of the seat bottom plane 1152. In some embodiments, the lowermost end 1150 of the recess 1128, 1130 is located within 110 mm of the seat bottom plane 1152. In some embodiments, the lowermost end 1150 of the recess 1128, 1130 is located about (i.e. within 10 mm) 100 mm of the seat bottom plane 1152. Such spacing provides sufficient distance to receive the arm region of the child while providing a lower panel to engage the hip region of the child.

An uppermost end 1156 of the recess 1128, 1130 is located at least 400 mm from the seat bottom plane 1152. In some embodiments, the uppermost end 1156 is located at least 425 mm from the seat bottom plane 1152. In some embodiments, the uppermost end 1156 is located at least 450 mm from the seat bottom plane 1152. In some embodiments, the uppermost end 1156 is located at least 475 mm from the seat bottom plane 1152. In some embodiments, the uppermost end 1156 is located about (i.e. within 10 mm) 480 mm from the seat bottom plane 1152. Such spacing provides sufficient distance to receive the shoulder and/or arm region of the child while providing an upper panel to support the head region of the child across a wide range of heights of the child.

The uppermost end 1156 of the recess 1128, 1130 is located within 50 mm of a reference point R located about (i.e. within 10 mm) 460 mm from the seat bottom plane 1152. The reference point R represents a center of gravity of a 3 year old test dummy sized according to Subpart W from 49 CFR part 572 at the time of filing this application.

Each side wing 1124, 1126 is formed to include a belt path opening 1176 located between the backrest 1118 and the recess 1128, 1130. An innermost end 1160 of the recess 1128, 1130 is spaced a distance from a seating surface 1160 provided by the seat back 1114 within a range of about 25 mm to about 75 mm. Each recess 1128, 1130 has a width from an innermost end 1162 to a medial side-impact barrier surface 1180 of at least 50 mm. In some embodiments, the recess 1128, 1130 has a width of at least 75 mm. In some embodiments, the recess 1128, 1130 has a width of about (i.e. within 10 mm) 60 mm. Such dimensions provide sufficient spacing for the shoulder and/or arm region of the child to move laterally during a side impact event to minimize chest displacement.

Each recess 1128, 1130 has a depth from the rearmost end 1158 to a forwardmost end 1182 of at least 75 mm. In some embodiments, the recess 1128, 1130 has a depth of at least 100 mm. In some embodiments, the recess 1128, 1130 has a depth of about (i.e. within 10 mm) 110 mm. Such dimensions provide sufficient forward projection of the side wings 1124, 1126 to restrain the shoulder and/or arm region of the child.

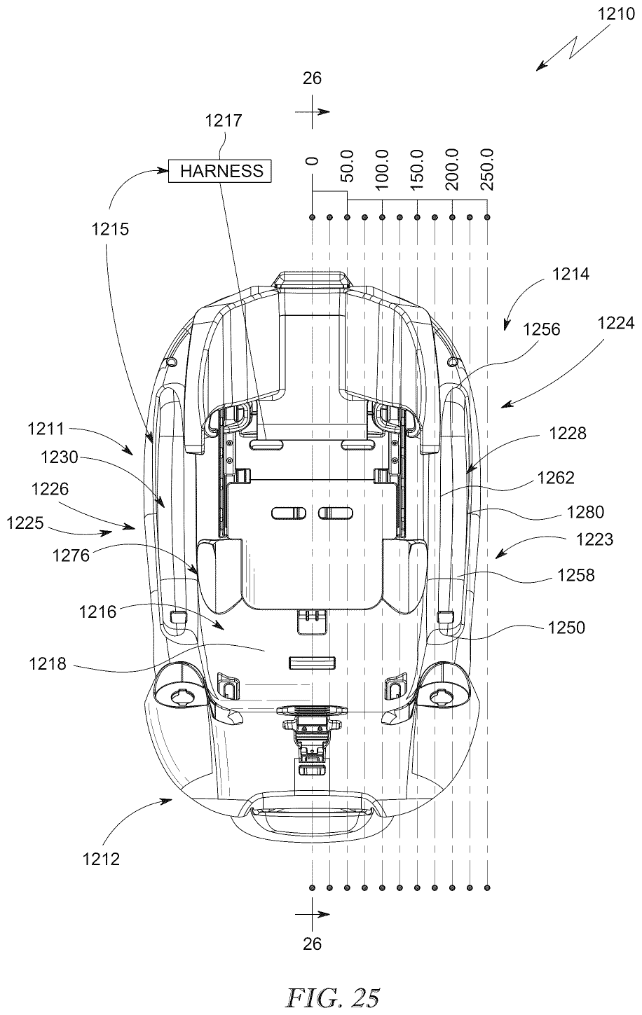

FIGS. 25-27 show a twelfth embodiment of a child restraint 1210 including recesses 1228, 1230 in side wings 1224, 1226 of backrest 1218. Child restraint 1210 is substantially similar to child restraint 10. Accordingly the disclosure of child restraint 10 is hereby incorporated herein for child restraint 1210.

Child restraint 1210 includes a seat shell 1211 and is formed to include a child-receiving space 1216 configured to hold a child for transportation in a vehicle. The seat shell 1211 includes a seat bottom 1212 and a seat back 1214 coupled to the seat bottom 1212. The seat back 1214 includes a backrest 1218 extending upwardly away from the seat bottom 1212 and a headrest 1220 coupled to the backrest 1218. The seat bottom 1212 and the seat back 1214 at least partially define the child-receiving space 1216.

In illustrative embodiments, the child restraint 1210 further includes a side-impact management system 1215 coupled to at least one of the seat bottom 1212 and the seat back 1214. The side-impact management system 1215 is configured to provide means for managing chest displacement of the child during a side impact to reduce a lateral force on a shoulder region of the child during the side impact so that chest displacement of the child is minimized.

The side-impact management system 1215 includes a child-restraint harness 1217 coupled to the seat shell 1211, a first side wing 1224 coupled to a first lateral side 1223 of the backrest 1218 and projecting forward therefrom, and a second side wing 1226 coupled to a second lateral side 1225 of the backrest and projecting forward therefrom. The child-restraint harness 1217 is configured to restrain the child in the child-receiving space 1216. Each side wing 1224, 1226 is formed to include a shoulder-receiving side-impact recess 1228, 1230. The shoulder-receiving side-impact recess 1228, 1230 of the first side wing 1224 or the second side wing 1226 is configured to receive the shoulder and/or arm region of the child during the side impact event.

A lowermost end 1250 of the recess 1228, 1230 is located within 125 mm of a seat bottom plane 1252 established by a seating surface 1254 of the seat bottom 1212. In some embodiments, the lowermost end 1250 of the recess 1228, 1230 is located within 115 mm of the seat bottom plane 1252. In some embodiments, the lowermost end 1250 of the recess 1228, 1230 is located within 110 mm of the seat bottom plane 1252. In some embodiments, the lowermost end 1250 of the recess 1228, 1230 is located about (i.e. within 10 mm) 100 mm of the seat bottom plane 1252. Such spacing provides sufficient distance to receive the arm region of the child while providing a lower panel to engage the hip region of the child.

An uppermost end 1256 of the recess 1228, 1230 is located at least 400 mm from the seat bottom plane 1252. In some embodiments, the uppermost end 1256 is located at least 425 mm from the seat bottom plane 1252. In some embodiments, the uppermost end 1256 is located at least 450 mm from the seat bottom plane 1252. In some embodiments, the uppermost end 1256 is located at least 475 mm from the seat bottom plane 1252. In some embodiments, the uppermost end 1256 is located about (i.e. within 10 mm) 460 mm from the seat bottom plane 1252. Such spacing provides sufficient distance to receive the shoulder and/or arm region of the child while providing an upper panel to support the head region of the child across a wide range of heights of the child.

The uppermost end 1256 of the recess 1228, 1230 is located within 50 mm of a reference point R located about (i.e. within 10 mm) 460 mm from the seat bottom plane 1252. The reference point R represents a center of gravity of a 3 year old test dummy sized according to Subpart W from 49 CFR part 572 at the time of filing this application.

Each side wing 1224, 1226 is formed to include a belt path opening 1276 located between the backrest 1118 and the recess 1228, 1230. A rearmost end 1258 of the recess 1228, 1230 is spaced a distance from a seating surface 1260 provided by the seat back 1214 within a range of about 25 mm to about 75 mm. Each recess 1228, 1230 has a width from an innermost end 1262 to a medial side-impact barrier surface 1280 of at least 50 mm. In some embodiments, the recess 1228, 1230 has a width of at least 75 mm. In some embodiments, the recess 1228, 1230 has a width of about (i.e. within 10 mm) 50 mm. Such dimensions provide sufficient spacing for the shoulder and/or arm region of the child to move laterally during a side impact event to minimize chest displacement.

Each recess 1228, 1230 has a depth from the rearmost end 1258 to a forwardmost end 1282 of at least 75 mm. In some embodiments, the recess 1228, 1230 has a depth of at least 100 mm. In some embodiments, the recess 1228, 1230 has a depth of about (i.e. within 10 mm) 75 mm. Such dimensions provide sufficient forward projection of the side wings 1224, 1226 to restrain the shoulder and/or arm region of the child.

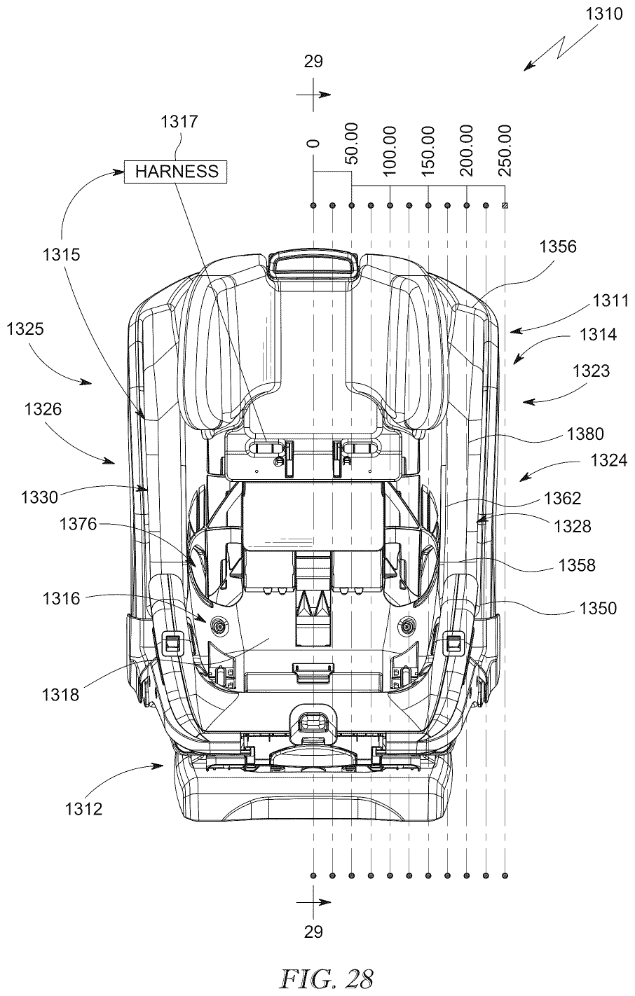

FIGS. 28-30 show a thirteenth embodiment of a child restraint 1310 including recesses 1328, 1330 in side wings 1324, 1326 of backrest 1318. Child restraint 1310 is substantially similar to child restraint 10. Accordingly the disclosure of child restraint 10 is hereby incorporated herein for child restraint 1310.

Child restraint 1310 includes a seat shell 1311 and is formed to include a child-receiving space 1316 configured to hold a child for transportation in a vehicle. The seat shell 1311 includes a seat bottom 1312 and a seat back 1314 coupled to the seat bottom 1312. The seat back 1314 includes a backrest 1318 extending upwardly away from the seat bottom 1312 and a headrest 1320 coupled to the backrest 1318. The seat bottom 1312 and the seat back 1314 at least partially define the child-receiving space 1316.

In illustrative embodiments, the child restraint 1310 further includes a side-impact management system 1315 coupled to at least one of the seat bottom 1312 and the seat back 1314. The side-impact management system 1315 is configured to provide means for managing chest displacement of the child during a side impact to reduce a lateral force on a shoulder region of the child during the side impact so that chest displacement of the child is minimized.

The side-impact management system 1315 includes a child-restraint harness 1317 coupled to the seat shell 1311, a first side wing 1324 coupled to a first lateral side 1323 of the backrest 1318 and projecting forward therefrom, and a second side wing 1326 coupled to a second lateral side 1325 of the backrest and projecting forward therefrom. The child-restraint harness 1317 is configured to restrain the child in the child-receiving space 1316. Each side wing 1324, 1326 is formed to include a shoulder-receiving side-impact recess 1328, 1330. The shoulder-receiving side-impact recess 1328, 1330 of the first side wing 1324 or the second side wing 1326 is configured to receive the shoulder and/or arm region of the child during the side impact event.

A lowermost end 1350 of the recess 1328, 1330 is located within 125 mm of a seat bottom plane 1352 established by a seating surface 1354 of the seat bottom 1312. In some embodiments, the lowermost end 1350 of the recess 1328, 1330 is located within 115 mm of the seat bottom plane 1352. In some embodiments, the lowermost end 1350 of the recess 1328, 1330 is located within 110 mm of the seat bottom plane 1352. In some embodiments, the lowermost end 1350 of the recess 1328, 1330 is located about (i.e. within 10 mm) 100 mm of the seat bottom plane 1352. Such spacing provides sufficient distance to receive the arm region of the child while providing a lower panel to engage the hip region of the child.

An uppermost end 1356 of the recess 1328, 1330 is located at least 400 mm from the seat bottom plane 1352. In some embodiments, the uppermost end 1356 is located at least 425 mm from the seat bottom plane 1352. In some embodiments, the uppermost end 1356 is located at least 450 mm from the seat bottom plane 1352. In some embodiments, the uppermost end 1356 is located at least 475 mm from the seat bottom plane 1352. In some embodiments, the uppermost end 1356 is located about (i.e. within 10 mm) 525 mm from the seat bottom plane 1352. Such spacing provides sufficient distance to receive the shoulder and/or arm region of the child while providing an upper panel to support the head region of the child across a wide range of heights of the child.

The uppermost end 1356 of the recess 1328, 1330 is located within 50 mm of a reference point R located about (i.e. within 10 mm) 460 mm from the seat bottom plane 1352. The reference point R represents a center of gravity of a 3 year old test dummy sized according to Subpart W from 49 CFR part 572 at the time of filing this application.

Each side wing 1324, 1326 is formed to include a belt path opening 1376 located between the backrest 1318 and the recess 1328, 1330. A rearmost end 1358 of the recess 1328, 1330 is spaced a distance from a seating surface 1360 provided by the seat back 1314 within a range of about 25 mm to about 75 mm. Each recess 1328, 1330 has a width from an innermost end 1362 to a medial side-impact barrier surface 1380 of at least 50 mm. In some embodiments, the recess 1328, 1330 has a width of at least 50 mm. In some embodiments, the recess 1328, 1330 has a width of about (i.e. within 10 mm) 50 mm. Such dimensions provide sufficient spacing for the shoulder and/or arm region of the child to move laterally during a side impact event to minimize chest displacement.

Each recess 1328, 1330 has a depth from the rearmost end 1358 to a forwardmost end 1382 of at least 75 mm. In some embodiments, the recess 1328, 1330 has a depth of at least 100 mm. In some embodiments, the recess 1328, 1330 has a depth of about (i.e. within 10 mm) 165 mm. Such dimensions provide sufficient forward projection of the side wings 1324, 1326 to restrain the shoulder and/or arm region of the child.

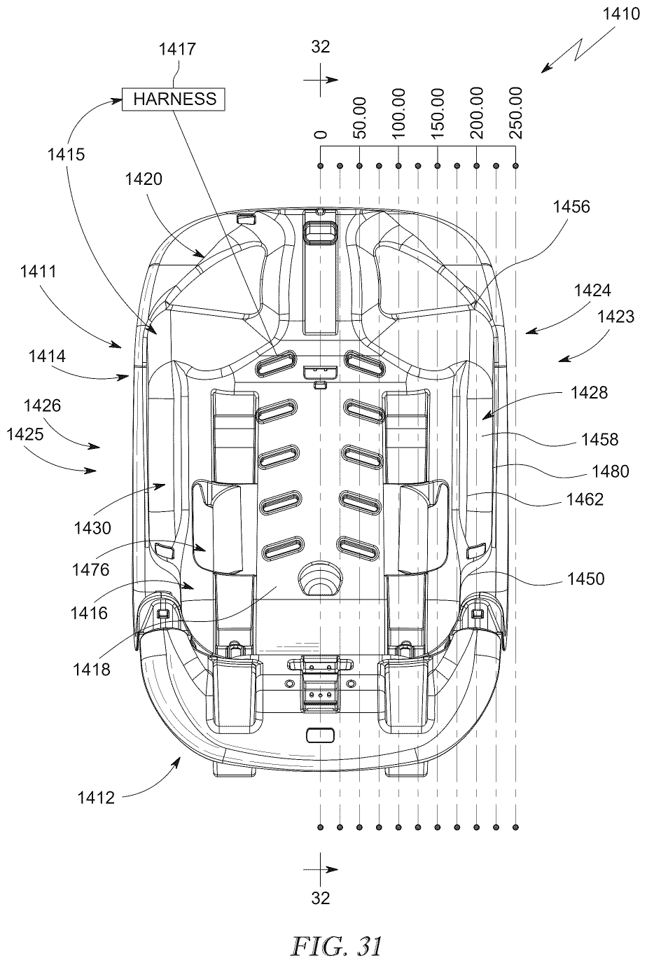

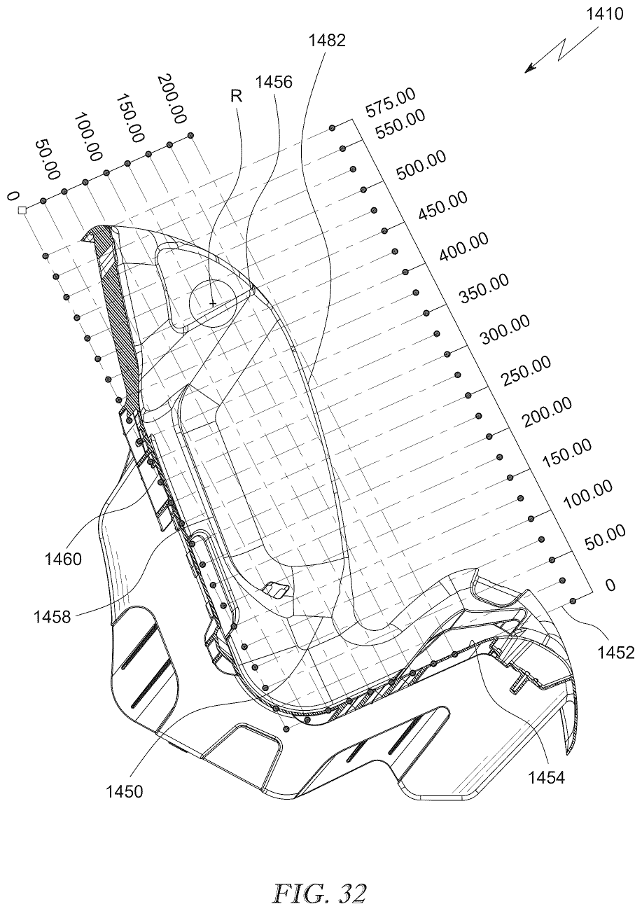

FIGS. 31 and 32 show a fourteenth embodiment of a child restraint 1410 including recesses 1428, 1430 in side wings 1424, 1426 of backrest 1418. Child restraint 1410 is substantially similar to child restraint 10. Accordingly the disclosure of child restraint 10 is hereby incorporated herein for child restraint 1410.

Child restraint 1410 includes a seat shell 1411 and is formed to include a child-receiving space 1416 configured to hold a child for transportation in a vehicle. The seat shell 1411 includes a seat bottom 1412 and a seat back 1414 coupled to the seat bottom 1412. The seat back 1414 includes a backrest 1418 extending upwardly away from the seat bottom 1412 and a headrest 1420 coupled to the backrest 1418. The seat bottom 1412 and the seat back 1414 at least partially define the child-receiving space 1416.

In illustrative embodiments, the child restraint 1410 further includes a side-impact management system 1415 coupled to at least one of the seat bottom 1412 and the seat back 1414. The side-impact management system 1415 is configured to provide means for managing chest displacement of the child during a side impact to reduce a lateral force on a shoulder region of the child during the side impact so that chest displacement of the child is minimized.

The side-impact management system 1415 includes a child-restraint harness 1417 coupled to the seat shell 1411, a first side wing 1424 coupled to a first lateral side 1423 of the backrest 1418 and projecting forward therefrom, and a second side wing 1426 coupled to a second lateral side 1425 of the backrest and projecting forward therefrom. The child-restraint harness 1417 is configured to restrain the child in the child-receiving space 1416. Each side wing 1424, 1426 is formed to include a shoulder-receiving side-impact recess 1428, 1430. The shoulder-receiving side-impact recess 1428, 1430 of the first side wing 1424 or the second side wing 1426 is configured to receive the shoulder and/or arm region of the child during the side impact event.

A lowermost end 1450 of the recess 1428, 1430 is located within 125 mm of a seat bottom plane 1452 established by a seating surface 1454 of the seat bottom 1412. In some embodiments, the lowermost end 1450 of the recess 1428, 1430 is located within 115 mm of the seat bottom plane 1252. In some embodiments, the lowermost end 1450 of the recess 1428, 1430 is located within 110 mm of the seat bottom plane 1452. In some embodiments, the lowermost end 1450 of the recess 1428, 1430 is located about (i.e. within 10 mm) 100 mm of the seat bottom plane 1452. Such spacing provides sufficient distance to receive the arm region of the child while providing a lower panel to engage the hip region of the child.

An uppermost end 1456 of the recess 1428, 1430 is located at least 400 mm from the seat bottom plane 1452. In some embodiments, the uppermost end 1456 is located at least 425 mm from the seat bottom plane 1452. In some embodiments, the uppermost end 1456 is located at least 450 mm from the seat bottom plane 1452. In some embodiments, the uppermost end 1456 is located at least 475 mm from the seat bottom plane 1452. In some embodiments, the uppermost end 1456 is located about (i.e. within 10 mm) 450 mm from the seat bottom plane 1452. Such spacing provides sufficient distance to receive the shoulder and/or arm region of the child while providing an upper panel to support the head region of the child across a wide range of heights of the child.

The uppermost end 1456 of the recess 1428, 1430 is located within 50 mm of a reference point R located about (i.e. within 10 mm) 460 mm from the seat bottom plane 1452. The reference point R represents a center of gravity of a 3 year old test dummy sized according to Subpart W from 49 CFR part 572 at the time of filing this application.

Each side wing 1424, 1426 is formed to include a belt path opening 1476 located between the backrest 1418 and the recess 1428, 1430. A rearmost end 1458 of the recess 1428, 1430 is spaced a distance from a seating surface 1460 provided by the seat back 1414 within a range of about 25 mm to about 75 mm. Each recess 1428, 1430 has a width from an innermost end 1462 to a medial side-impact barrier surface 1480 of at least 50 mm. In some embodiments, the recess 1428, 1430 has a width of at least 75 mm. In some embodiments, the recess 1428, 1430 has a width of about (i.e. within 10 mm) 50 mm. Such dimensions provide sufficient spacing for the shoulder and/or arm region of the child to move laterally during a side impact event to minimize chest displacement.

Each recess 1428, 1430 has a depth from the rearmost end 1458 to a forwardmost end 1482 of at least 75 mm. In some embodiments, the recess 1428, 1430 has a depth of at least 100 mm. In some embodiments, the recess 1428, 1430 has a depth of about (i.e. within 10 mm) 140 mm. Such dimensions provide sufficient forward projection of the side wings 1424, 1426 to restrain the shoulder and/or arm region of the child.

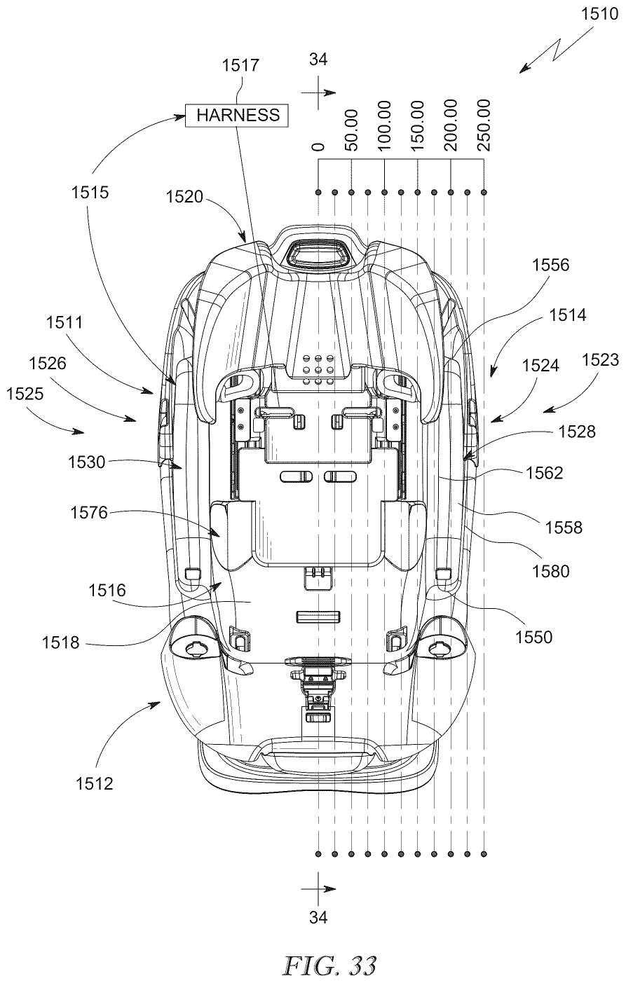

FIGS. 33-35 show a fifteenth embodiment of a child restraint 1510 including recesses 1528, 1530 in side wings 1524, 1526 of backrest 1518. Child restraint 1510 is substantially similar to child restraint 10. Accordingly the disclosure of child restraint 10 is hereby incorporated herein for child restraint 1510.

Child restraint 1510 includes a seat shell 1511 and is formed to include a child-receiving space 1516 configured to hold a child for transportation in a vehicle. The seat shell 1511 includes a seat bottom 1512 and a seat back 1514 coupled to the seat bottom 1512. The seat back 1514 includes a backrest 1518 extending upwardly away from the seat bottom 1512 and a headrest 1520 coupled to the backrest 1518. The seat bottom 1512 and the seat back 1514 at least partially define the child-receiving space 1516.

In illustrative embodiments, the child restraint 1510 further includes a side-impact management system 1515 coupled to at least one of the seat bottom 1512 and the seat back 1514. The side-impact management system 1515 is configured to provide means for managing chest displacement of the child during a side impact to reduce a lateral force on a shoulder region of the child during the side impact so that chest displacement of the child is minimized.

The side-impact management system 1515 includes a child-restraint harness 1517 coupled to the seat shell 1511, a first side wing 1524 coupled to a first lateral side 1523 of the backrest 1518 and projecting forward therefrom, and a second side wing 1526 coupled to a second lateral side 1525 of the backrest and projecting forward therefrom. The child-restraint harness 1517 is configured to restrain the child in the child-receiving space 1516. Each side wing 1524, 1526 is formed to include a shoulder-receiving side-impact recess 1528, 1530. The shoulder-receiving side-impact recess 1528, 1530 of the first side wing 1524 or the second side wing 1526 is configured to receive the shoulder and/or arm region of the child during the side impact event.

A lowermost end 1550 of the recess 1528, 1530 is located within 125 mm of a seat bottom plane 1552 established by a seating surface 1554 of the seat bottom 1512. In some embodiments, the lowermost end 1550 of the recess 1528, 1530 is located within 115 mm of the seat bottom plane 1552. In some embodiments, the lowermost end 1550 of the recess 1528, 1530 is located within 110 mm of the seat bottom plane 1552. In some embodiments, the lowermost end 1550 of the recess 1528, 1530 is located about (i.e. within 10 mm) 100 mm of the seat bottom plane 1552. Such spacing provides sufficient distance to receive the arm region of the child while providing a lower panel to engage the hip region of the child.

An uppermost end 1556 of the recess 1528, 1530 is located at least 400 mm from the seat bottom plane 1552. In some embodiments, the uppermost end 1556 is located at least 425 mm from the seat bottom plane 1552. In some embodiments, the uppermost end 1556 is located at least 450 mm from the seat bottom plane 1552. In some embodiments, the uppermost end 1556 is located at least 475 mm from the seat bottom plane 1552. In some embodiments, the uppermost end 1556 is located about (i.e. within 10 mm) 500 mm from the seat bottom plane 1552. Such spacing provides sufficient distance to receive the shoulder and/or arm region of the child while providing an upper panel to support the head region of the child across a wide range of heights of the child.

The uppermost end 1556 of the recess 1528, 1530 is located within 50 mm of a reference point R located about (i.e. within 10 mm) 460 mm from the seat bottom plane 1552. The reference point R represents a center of gravity of a 3 year old test dummy sized according to Subpart W from 49 CFR part 572 at the time of filing this application.

Each side wing 1524, 1526 is formed to include a belt path opening 1576 located between the backrest 1518 and the recess 1528, 1530. A rearmost end 1558 of the recess 1528, 1530 is spaced a distance from a seating surface 1560 provided by the seat back 1514 within a range of about 25 mm to about 75 mm. Each recess 1528, 1530 has a width from an innermost end 1562 to a medial side-impact barrier surface 1580 of at least 50 mm. In some embodiments, the recess 1528, 1530 has a width of at least 50 mm. In some embodiments, the recess 1528, 1530 has a width of about (i.e. within 10 mm) 50 mm. Such dimensions provide sufficient spacing for the shoulder and/or arm region of the child to move laterally during a side impact event to minimize chest displacement.

Each recess 1528, 1530 has a depth from the rearmost end 1558 to a forwardmost end 1582 of at least 75 mm. In some embodiments, the recess 1528, 1530 has a depth of at least 100 mm. In some embodiments, the recess 1528, 1530 has a depth of about (i.e. within 10 mm) 100 mm. Such dimensions provide sufficient forward projection of the side wings 1524, 1526 to restrain the shoulder and/or arm region of the child.

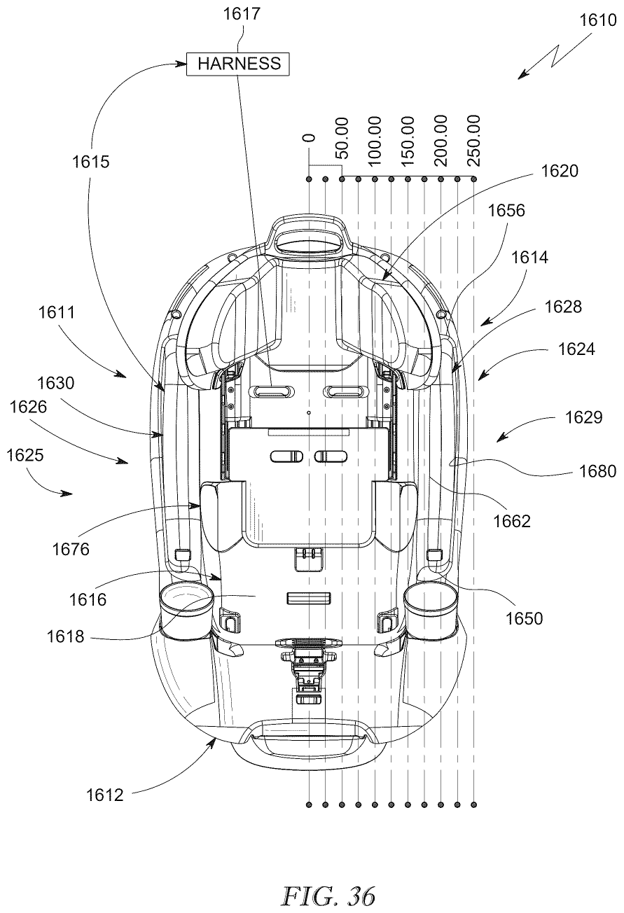

FIGS. 36-38 show a sixteenth embodiment of a child restraint 1610 including recesses 1628, 1630 in side wings 1624, 1626 of backrest 1618. Child restraint 1610 is substantially similar to child restraint 10. Accordingly the disclosure of child restraint 10 is hereby incorporated herein for child restraint 1610.

Child restraint 1610 includes a seat shell 1611 and is formed to include a child-receiving space 1616 configured to hold a child for transportation in a vehicle. The seat shell 1611 includes a seat bottom 1612 and a seat back 1614 coupled to the seat bottom 1612. The seat back 1614 includes a backrest 1618 extending upwardly away from the seat bottom 1612 and a headrest 1620 coupled to the backrest 1618. The seat bottom 1612 and the seat back 1614 at least partially define the child-receiving space 1616.

In illustrative embodiments, the child restraint 1610 further includes a side-impact management system 1615 coupled to at least one of the seat bottom 1612 and the seat back 1614. The side-impact management system 1615 is configured to provide means for managing chest displacement of the child during a side impact to reduce a lateral force on a shoulder region of the child during the side impact so that chest displacement of the child is minimized.

The side-impact management system 1615 includes a child-restraint harness 1617 coupled to the seat shell 1611, a first side wing 1624 coupled to a first lateral side 1623 of the backrest 1618 and projecting forward therefrom, and a second side wing 1626 coupled to a second lateral side 1625 of the backrest and projecting forward therefrom. The child-restraint harness 1617 is configured to restrain the child in the child-receiving space 1616. Each side wing 1624, 1626 is formed to include a shoulder-receiving side-impact recess 1628, 1630. The shoulder-receiving side-impact recess 1628, 1630 of the first side wing 1624 or the second side wing 1626 is configured to receive the shoulder and/or arm region of the child during the side impact event.

A lowermost end 1650 of the recess 1628, 1630 is located within 125 mm of a seat bottom plane 1652 established by a seating surface 1654 of the seat bottom 1612. In some embodiments, the lowermost end 1650 of the recess 1628, 1630 is located within 115 mm of the seat bottom plane 1652. In some embodiments, the lowermost end 1650 of the recess 1628, 1630 is located within 110 mm of the seat bottom plane 1652. In some embodiments, the lowermost end 1650 of the recess 1628, 1630 is located about (i.e. within 10 mm) 100 mm of the seat bottom plane 1652. Such spacing provides sufficient distance to receive the arm region of the child while providing a lower panel to engage the hip region of the child.

An uppermost end 1656 of the recess 1628, 1630 is located at least 400 mm from the seat bottom plane 1652. In some embodiments, the uppermost end 1656 is located at least 425 mm from the seat bottom plane 1652. In some embodiments, the uppermost end 1656 is located at least 450 mm from the seat bottom plane 1652. In some embodiments, the uppermost end 1656 is located at least 460 mm from the seat bottom plane 1652. In some embodiments, the uppermost end 1656 is located about (i.e. within 10 mm) 465 mm from the seat bottom plane 1652. Such spacing provides sufficient distance to receive the shoulder and/or arm region of the child while providing an upper panel to support the head region of the child across a wide range of heights of the child.

The uppermost end 1656 of the recess 1628, 1630 is located within 50 mm of a reference point R located about (i.e. within 10 mm) 460 mm from the seat bottom plane 1652. The reference point R represents a center of gravity of a 3 year old test dummy sized according to Subpart W from 49 CFR part 572 at the time of filing this application.

Each side wing 1624, 1626 is formed to include a belt path opening 1676 located between the backrest 1618 and the recess 1628, 1630. A rearmost end 1658 of the recess 1628, 1630 is spaced a distance from a seating surface 1660 provided by the backrest 1618 within a range of about 25 mm to about 75 mm. Each recess 1628, 1630 has a width from the rearmost end 1658 to a medial side-impact barrier surface 1680 of at least 50 mm. In some embodiments, the recess 1628, 1630 has a width of at least 50 mm. In some embodiments, the recess 1628, 1630 has a width of about (i.e. within 10 mm) 50 mm. Such dimensions provide sufficient spacing for the shoulder and/or arm region of the child to move laterally during a side impact event to minimize chest displacement.

Each recess 1628, 1630 has a depth from the rearmost end 1658 to a forwardmost end 1682 of at least 75 mm. In some embodiments, the recess 1628, 1630 has a depth of at least 100 mm. In some embodiments, the recess 1628, 1630 has a depth of about (i.e. within 10 mm) 75 mm. Such dimensions provide sufficient forward projection of the side wings 1624, 1626 to restrain the shoulder and/or arm region of the child.

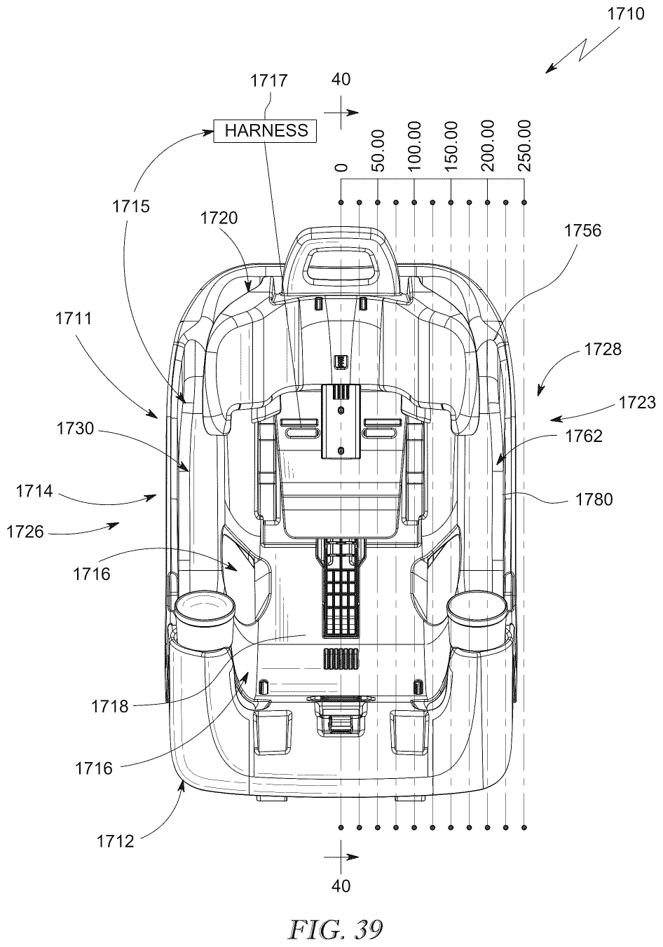

FIGS. 39-41 show a seventeenth embodiment of a child restraint 1710 including recesses 1728, 1730 in side wings 1724, 1726 of backrest 1718. Child restraint 1710 is substantially similar to child restraint 10. Accordingly the disclosure of child restraint 10 is hereby incorporated herein for child restraint 1710.

Child restraint 1710 includes a seat shell 1711 and is formed to include a child-receiving space 1716 configured to hold a child for transportation in a vehicle. The seat shell 1711 includes a seat bottom 1712 and a seat back 1714 coupled to the seat bottom 1712. The seat back 1714 includes a backrest 1718 extending upwardly away from the seat bottom 1712 and a headrest 1720 coupled to the backrest 1718. The seat bottom 1712 and the seat back 1714 at least partially define the child-receiving space 1716.

In illustrative embodiments, the child restraint 1710 further includes a side-impact management system 1715 coupled to at least one of the seat bottom 1712 and the seat back 1714. The side-impact management system 1715 is configured to provide means for managing chest displacement of the child during a side impact to reduce a lateral force on a shoulder region of the child during the side impact so that chest displacement of the child is minimized.

The side-impact management system 1715 includes a child-restraint harness 1717 coupled to the seat shell 1711, a first side wing 1724 coupled to a first lateral side 1723 of the backrest 1718 and projecting forward therefrom, and a second side wing 1726 coupled to a second lateral side 1725 of the backrest and projecting forward therefrom. The child-restraint harness 1717 is configured to restrain the child in the child-receiving space 1716. Each side wing 1724, 1726 is formed to include a shoulder-receiving side-impact recess 1728, 1730. The shoulder-receiving side-impact recess 1728, 1730 of the first side wing 1724 or the second side wing 1726 is configured to receive the shoulder and/or arm region of the child during the side impact event.

A lowermost end 1750 of the recess 1728, 1730 is located within 125 mm of a seat bottom plane 1752 established by a seating surface 1754 of the seat bottom 1712. In some embodiments, the lowermost end 1750 of the recess 1728, 1730 is located within 115 mm of the seat bottom plane 1752. In some embodiments, the lowermost end 1750 of the recess 1728, 1730 is located within 110 mm of the seat bottom plane 1752. In some embodiments, the lowermost end 1750 of the recess 1728, 1730 is located about (i.e. within 10 mm) 100 mm of the seat bottom plane 1752. Such spacing provides sufficient distance to receive the arm region of the child while providing a lower panel to engage the hip region of the child.

An uppermost end 1756 of the recess 1728, 1730 is located at least 400 mm from the seat bottom plane 1752. In some embodiments, the uppermost end 1756 is located at least 425 mm from the seat bottom plane 1752. In some embodiments, the uppermost end 1756 is located at least 450 mm from the seat bottom plane 1752. In some embodiments, the uppermost end 1756 is located at least 475 mm from the seat bottom plane 1752. In some embodiments, the uppermost end 1756 is located about (i.e. within 10 mm) 480 mm from the seat bottom plane 1752. Such spacing provides sufficient distance to receive the shoulder and/or arm region of the child while providing an upper panel to support the head region of the child across a wide range of heights of the child.

The uppermost end 1756 of the recess 1728, 1730 is located within 50 mm of a reference point R located about (i.e. within 10 mm) 460 mm from the seat bottom plane 1752. The reference point R represents a center of gravity of a 3 year old test dummy sized according to Subpart W from 49 CFR part 572 at the time of filing this application.

Each side wing 1724, 1726 is formed to include a belt path opening 1776 located between the backrest 1718 and the recess 1728, 1730. A rearmost end 1758 of the recess 1728, 1730 is spaced a distance from a seating surface 1760 provided by the backrest 1718 within a range of about 25 mm to about 75 mm. Each recess 1728, 1730 has a width from the rearmost end 1758 to a medial side-impact barrier surface 1780 of at least 50 mm. In some embodiments, the recess 1728, 1730 has a width of at least 50 mm. In some embodiments, the recess 1728, 1730 has a width of about (i.e. within 10 mm) 60 mm. Such dimensions provide sufficient spacing for the shoulder and/or arm region of the child to move laterally during a side impact event to minimize chest displacement.

Each recess 1728, 1730 has a depth from the rearmost end 1758 to a forwardmost end 1782 of at least 75 mm. In some embodiments, the recess 1728, 1730 has a depth of at least 100 mm. In some embodiments, the recess 1728, 1730 has a depth of about (i.e. within 10 mm) 100 mm. Such dimensions provide sufficient forward projection of the side wings 1724, 1726 to restrain the shoulder and/or arm region of the child.

The dimensions described above with respect to the embodiments shown in FIGS. 22-41 are applicable to child restraint 10. The dimensions described above with respect to the embodiments shown in FIGS. 22-41 are applicable to child restraint 210. The dimensions described above with respect to the embodiments shown in FIGS. 22-41 are applicable to child restraint 310. The dimensions described above with respect to the embodiments shown in FIGS. 22-41 are applicable to child restraint 410. The dimensions described above with respect to the embodiments shown in FIGS. 22-41 are applicable to child restraint 510. The dimensions described above with respect to the embodiments shown in FIGS. 22-41 are applicable to child restraint 610. The dimensions described above with respect to the embodiments shown in FIGS. 22-41 are applicable to child restraint 710. The dimensions described above with respect to the embodiments shown in FIGS. 22-41 are applicable to child restraint 810. The dimensions described above with respect to the embodiments shown in FIGS. 22-41 are applicable to child restraint 910. The dimensions described above with respect to the embodiments shown in FIGS. 22-41 are applicable to child restraint 1010.

A juvenile seat 10 includes a seat bottom 12 and a seat back 14 coupled to the seat bottom 12 as shown in FIG. 1. The seat bottom 12 and the seat back 14 cooperate to define a child-receiving space 16 configured to receive a child for transportation in a vehicle. The seat back 14 is configured to reduce forces experienced by the child during side impacts by improving upon chest displacement as shown in FIGS. 3-6.

The seat back 14 includes a backrest 18 and a headrest 20 as shown in FIGS. 1 and 3-6. The backrest 18 is coupled to the seat bottom 12 and extends upwardly away from the seat bottom 12. The headrest 20 is coupled to the backrest 18 and may be movable upwardly and downwardly along the backrest 18 to accommodate different heights of the child as the child grows. The headrest 20 is sized and structured to support the head of the child while the backrest 18 is sized and structured to support the torso of the child separately from the headrest 20 during a side impact.

The backrest 18 may include left and right side wings 24, 26 coupled to respective lateral sides of the backrest 18 as shown in FIG. 1. The backrest 18 supports the headrest 20 relative to the rest of the juvenile seat 10. The left and right side wings 24, 26 extend forward away from the backrest 18 so that the side wings 24, 26 at least partially surround the child's sides including their shoulder and/or arm regions.

Each of the side wings 24, 26 is formed to include a recess 28, 30 as shown in FIGS. 1 and 2. The recesses 28, 30 provide space for the child's shoulder and/or arm regions to extend into during a side impact, thereby lessening forces experienced by the child. Each recess 28, 30 defines an empty space and a flexible soft-goods or trim material 60 overlies the side wings 24, 26 and the recesses 28, 30. In some embodiments, the child's shoulder and/or arm regions extend into the recesses 28, 30 without contacting any rigid or force-reducing structures (e.g. foam, airbag, etc.). In some embodiments, the recess 28, 30 is filled at least partially with a foam material, an airbag, etc.

Each of the side wings 24, 26 includes an upper panel 40, a lower panel 42, and a medial panel 44 between the upper panel 40 and the lower panel 42 as shown in FIG. 1. The upper panel 40 supports side wings of the headrest 20 during side impacts. The lower panel 42 supports the child's hips during side impacts. The medial panel 44 is formed to include the recess 28, 30 such that at least a portion of the medial panel 44 is laterally further from the child than the upper panel 40 and the lower panel 42 to provide the spacing for the child's shoulder and/or arm regions during side impacts. The medial panel 44 may contact and support the shoulder or arm region of the child during side impacts, but the upper and lower panels 40, 42 are configured to engage the child before the medial panel 44 during the side impact event.

Some juvenile seats include a turn-back flange F that provides a smooth, convexly-shaped surface of the side wings 24, 26 as shown in FIGS. 19 and 20. The juvenile seat 10 of the illustrative embodiment includes a turn-back flange 50, as shown in FIG. 2, that is smaller in comparison to other turn-back flanges F of other juvenile seats. The turn back flange 50 has a width 52 that is smaller than a width 54 of the recesses 28, 30. The turn-back flange 50 also has a depth 56 that is less than a depth 58 of the recesses 28, 30. Other juvenile seats do not have such dimensions because they do not include recesses 28, 30.

Some juvenile seats include a “turn-back” shell design shown in FIG. 20. In one example, portions of the backrest provide sidewall recesses 28, 30 on each side of the backrest and creating a singular wall along the side wings. In another example, the backrest has a sidewall recess on each side wing and a width of the turn-back flange is reduced. In another example, the backrest has a sidewall recess on each side wing and a depth of the turn-back flange is reduced. In another embodiment, both the width and the depth of the turn-back flange are reduced.

The proposed design improves displacement scores in many ways. First, during a side impact collision, the proposed design provides additional space for the shoulder and/or elbow of the child to move relative to the shell or the shell to move relative to the shoulder/arm/elbow of the child. This allows the shell to deform and absorb energy during the collision while providing space for body parts of the child to move into to increase an amount of time before the body parts contact areas of the backrest thereby decreasing forces experienced by the child. Another benefit of the proposed design allows for the shell wing to bend and conform to the intruding door. Testing has shown structural elements of the side wings close to the child directly loads the shoulder/arm and increases chest displacement scores. Shells without recesses do not flex as much and quickly transfer load from the door into the child's arm/torso, increasing forces experienced by the child. The proposed design provides increased support to the child's shoulder and hips to manage the load to the shoulder/arm/torso. The proposed designs satisfy federal safety standard FMVSS 213a and meet a chest displacement score limit of 23 mm. These results were unexpected because it was previously thought that more confinement (i.e. a tighter space between the side wings provided by the larger turn-back flange) would provide more support and protection for the child during side impacts, or that an empty space would not improve chest deflection scores.

The present disclosure improves chest deflection scores without the addition of a secondary piece and/or with removal of structures. Some juvenile seat include a separate brace along the outside of the seat shell or a compressible element such as an airbag that must be added/assembled and increases the product cost. The proposed design offers flexibility to provide side impact protection both with or without the use of aforementioned element(s).

1. A child restraint comprising a seat shell including a seat bottom and a seat back coupled to the seat bottom and including a backrest extending upwardly away from the seat bottom and a headrest coupled to the backrest, the seat bottom and the seat back at least partially defining a child-receiving space configured to hold a child for transportation in a vehicle, and
a side-impact management system configured to provide means for managing chest displacement of the child during a side impact to reduce a lateral force on a shoulder region of the child during the side impact so that chest displacement of the child is minimized.

2. The child restraint of claim 1, wherein the side-impact management system includes a child-restraint harness coupled to the seat shell and configured to block movement of a torso of the child relative to the seat shell, a first side wing coupled to a first lateral side of the backrest and projecting forward therefrom, and a second side wing coupled to a second lateral side of the backrest and projecting forward therefrom, and
wherein each side wing is formed to include a shoulder-receiving side-impact recess, and wherein the shoulder-receiving side-impact recess of the first side wing or the second side wing is configured to receive the shoulder region of the child during the side impact event to allow movement of the shoulder region included in the torso of the child seated in the child-receiving space in a first lateral direction as at least a portion of either of the side wings moves in a second lateral direction, opposite the first lateral direction, toward the shoulder region of the child so that the child-restraint harness catches the torso of the child during the side impact event as the shoulder region of the child moves in the first lateral direction to minimize the chest displacement of the child.

3. The child restraint of claim 2, wherein the child restraint further includes an outer trim covering each shoulder-receiving side-impact recess of the side wings, and the outer trim is spaced apart from at least a portion of each side wing so that each recess provides an empty space between the outer trim and at least the portion of each side wing.

4. The child restraint of claim 2, wherein each of the side wings includes an upper panel configured to restrain the head of the child during the side impact event, a lower panel configured to restrain a hip region of the child during the side impact event, and a medial panel extending between and interconnecting the upper panel and the lower panel, and the recess is defined below the upper panel, above the lower panel, and laterally adjacent to at least a portion of the medial panel.

5. The child restraint of claim 4, wherein the medial panel includes a rear segment coupled to the backrest and extending away from the backrest in a forward direction, a laterally-extending segment coupled to a forwardmost end of the rear segment and extending away from the rear segment in a lateral direction, and an outwardly-extending segment coupled to an outermost end of the laterally-extending segment and extending away from the backrest in the forward direction to define the recess forward of the laterally-extending segment and laterally adjacent to the outwardly-extending segment.

6. The child restraint of claim 5, wherein the rear segment is formed to include a belt-path aperture located rearward of the recess.

7. The child restraint of claim 5, wherein the upper panel includes an outwardly-extending segment coupled to the backrest and extending away from the backrest in the forward direction with the rear segment of the medial panel and a laterally-extending segment coupled to a forwardmost end of the outwardly-extending segment of the upper panel and extending away from the outwardly-extending segment of the upper panel in the lateral direction with the laterally-extending segment of the medial panel.

8. The child restraint of claim 5, wherein the seat shell further includes a turn-back flange having an inner end coupled to an outer end of the upper panel, the medial panel, and the lower panel, and wherein the turn-back flange has a first width defined between the inner end of the turn-back flange and an outer end of the turn-back flange, and the recess has a second width defined between the outer end of the outwardly-extending segment of the medial panel and the forwardmost end of the rear segment of the medial panel, the second width being greater than the first width.

9. The child restraint of claim 8, wherein the second width is greater than a third width defined between a forwardmost end of an outwardly-extending segment of the upper panel and the outer end of the upper panel.

10. The child restraint of claim 5, wherein the laterally-extending segment of the medial panel includes a substantially linear middle segment, an upper, curved segment coupled to an upper end of the substantially linear middle segment and to a forwardmost end of the upper panel, and a lower, curved segment coupled to a lower end of the substantially linear middle segment and to a forwardmost end of the lower panel.

11. A child restraint comprising
a seat bottom,
a backrest coupled to the seat bottom and extending upwardly away from the seat bottom, and
a side-impact management system including a child-restraint harness coupled to the seat bottom and the seat back and configured to block movement of a child relative to the seat bottom and the seat back, a first side wing coupled to a first lateral end of the backrest, and a second side wing coupled to a second lateral end of the backrest,
wherein the first and second side wings each include an upper section having a first side-impact barrier surface spaced a first distance from a centerline of the child restraint, lower section having a second side-impact barrier surface spaced a second distance from the centerline of the child restraint, and a medial section having a medial side-impact barrier surface positioned between the first and second side-impact barrier surfaces and spaced a third distance from the centerline of the child restraint greater than the first and second distances, and
wherein each medial side-impact barrier surface is formed to include a recess having a height extending along a majority of a height of the backrest.

12. The child restraint of claim 11, wherein a lowermost end of the recess is located within 125 mm of a seat bottom plane established by a seating surface of the seat bottom.

13. The child restraint of claim 12, wherein an uppermost end of the recess is located at least 400 mm from the seat bottom plane.

14. The child restraint of claim 13, wherein the uppermost end of the recess is located within 50 mm of a reference point located about 460 mm from the seat bottom plane.

15. The child restraint of claim 11, wherein a rearmost end of the recess is spaced a distance from a seating surface provided by the backrest within a range of about 25 mm to about 75 mm.

16. The child restraint of claim 15, wherein each side wing is formed to include a first belt path opening located between the backrest and the recess.

17. The child restraint of claim 16, wherein each side wing is formed to include a second belt path opening located forward of the first belt path opening and beneath the recess.

18. The child restraint of claim 15, wherein each recess has a width from the rearmost end to the medial side-impact barrier surface of at least 100 mm.

19. A method of testing a child restraint, the method comprising:
installing the child restraint on a sled, the child restraint including a backrest, a first side wing coupled to a first lateral end of the backrest and extending forward therefrom, and a second side wing coupled to a second lateral end of the backrest and extending forward therefrom, the first and second side wings each formed to include a recess,
installing a test dummy on the child restraint, wherein the test dummy is sized according to Subpart W from 49 CFR part 572,
advancing the sled down a track while the child restraint is in a sideways-facing orientation relative to a direction of travel of the sled, and
stopping the sled to simulate a side impact event,
wherein when the sled is stopped, a shoulder region of the test dummy extends into the recess of the first side wing or the second side wing to minimize chest displacement of the test dummy during the side impact event.

20. The method of claim 19, wherein each side wing of the child restraint includes an upper section having a first side-impact barrier surface spaced a first distance from a centerline of the child restraint, lower section having a second side-impact barrier surface spaced a second distance from the centerline of the child restraint, and a medial section having a medial side-impact barrier surface positioned between the first and second side-impact barrier surfaces and spaced a third distance from the centerline of the child restraint greater than the first and second distances, and
wherein each medial side-impact barrier surface is formed to include the recess and the shoulder region of the test dummy enters the recess during the side impact event while a head of the test dummy is restrained by the upper section and a hip of the test dummy is in restrained by the lower section.

21. The method of claim 20, wherein a lowermost end of the recess is located within 125 mm of a seat bottom plane established by a seating surface of a seat bottom of the child restraint, and an uppermost end of the recess is located at least 400 mm from the seat bottom plane.
